(19) United States
(12) Patent Application Publication
(10) Pub. No.: US 2007/0185258 A1
(43) Pub. Date: Aug. 9, 2007

(54) Use of structured water-soluble polymers obtained by controlled radical polymerization as a dispersant and agent for assisting in the grinding of mineral materials

(75) Inventors: Jean-Marc Suau, Lucenay (FR); Christian Jacquemet, Lyon (FR); Yves Kensicher, Theize (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COATEX S.A.S., GENAY (FR)

(21) Appl. No.: 10/584,147

(22) PCT Filed: Dec. 22, 2004
(86) PCT No.: PCT/FR04/03330

§ 371 Date: Jun. 22, 2006

(30) Foreign Application Priority Data
Dec. 24, 2003 (FR) 0315385

(51) Int. Cl. C08F 4/00; C09D 5/02

(52) U.S. Cl. 524/556; 526/193

(57) ABSTRACT

The invention relates to the use, as a dispersant and/or a grinding aid agent for pigments and/or mineral fillers in aqueous suspension, of a water soluble polymer with a controlled structure obtained by a controlled free radical polymerization process putting into practice a particular alkoxyamine as a polymerization initiator.

The present invention relates to the field of dispersants and grinding aid agents for mineral matter, suitable respectively for improving the stability of the aqueous dispersions of mineral matter, and for facilitating the grinding of said mineral matter in aqueous suspension.

The invention relates primarily to the use, as dispersant and/or grinding aid agent for pigments and/or mineral fillers in aqueous suspension, of a water soluble polymer, with a controlled structure obtained by a controlled free radical polymerization method employing, as polymerization initiator, a particular alkoxyamine with the general formula (A): 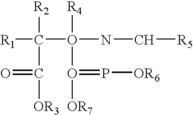
where:
R₁ and R₂ represent a linear or branched alkyl radical, with 1 to 5 carbon atoms,
R₃ is a hydrogen atom, a linear or branched alkyl radical with 1 to 8 carbon atoms, a phenyl radical, a cation such as Li⁺, Na⁺, K⁺, H₄N⁺, Bu₃HN⁺ with Bu=butyl,
R₄ is a linear or branched alkyl radical with 1 to 8 carbon atoms, and preferably a tertbutyl radical,
R₅ is a linear or branched alkyl radical with 1 to 8 carbon atoms, and preferably a tertbutyl radical,
R₆ and R₇ represent a linear or branched alkyl radical with 1 to 8 carbon atoms, and preferably an ethyl radical.

The invention further relates to methods for aqueous dispersing and for grinding of pigments and/or mineral fillers in aqueous supensions, which put into practice this water soluble polymer.

The invention further relates to the aqueous dispersions and suspensions of pigments and/or mineral fillers thereby obtained.

The invention further relates to the use of the aqueous suspensions of pigments and/or mineral fillers thereby obtained in the paper field and in particular in the coating of the paper and the filling of the paper, or even in the fields of water based paints, plastics, cement, ceramics, detergents, cosmetics, and drilling muds.

The invention further relates to the paper formulations, water based paints, plastic compositions, cements, ceramic compositions, detergent compositions, cosmetic compositions, and the drilling muds thereby obtained.

The invention further relates to the direct use as a dispersant of said water soluble polymers in paper formulations, water based paints, cements, ceramic compositions, detergent compositions, cosmetic compositions and drilling muds.

It further relates to the paper formulations, water based paints, cements, ceramic compositions, detergent compositions, cosmetic compositions and drilling muds thereby obtained by direct use, as dispersant, of said water soluble polymers.

The manufacture, handling, transport and use of aqueous suspensions of mineral matter have always been operations in which the stability and the viscosity of these suspensions represent a crucial problem for a person skilled in the art, in order to avoid harmful mechanisms such as sedimentation, caking, pigment incompatibility or even problems of pumpability due to an excessively high viscosity.

Moreover, the person skilled in the art is also often led to perform a so-called grinding operation, which consists in reducing the size of the particles of pigments and/or mineral fillers via an input of energy, in order to adapt the particle size distribution of the particles to their intended application.

Thus, additives called “dispersants” have gradually been developed, suitable for improving the stability of said suspensions, as well as additives called “grinding aid agents” employed to facilitate the size reduction of the particles. These additives are generally based on acrylic and methacrylic polymers, as demonstrated by all the documents cited in the prior art relative to this application.

Numerous applied research projects and several patents have rapidly guided the person skilled in the art towards the choice of “controlled structure” polymers. We shall detail this concept through a number of examples and provide a precise meaning thereof, that will be used in the rest of this application.

In addition to the specific knowledge consisting of the synthesis of particular polymers, the person skilled in the art finds the following general teaching in patent U.S. Pat. No. 5,424,364: “controlled structure polymers” are effective dispersants for mineral fillers. Through a reading of this document, this expression must be interpreted as AB block polymers, to the detriment of polymers with a statistical architecture.

This concept is found in patent U.S. Pat. No. 5,231,131 which teaches the person skilled in the art that the purer these structured polymers, the more effective they are as dispersants: the privileged structure here is that of block or comb polymers, to the detriment of a random architecture.

Similarly, as regards the grinding methods, it appears in the document “Wetting and dispersing agents” (Chimia, 56, 2002, 170-176) that block copolymers can behave as very effective grinding aid agents for inorganic pigments used in paints and plastics.

In agreement with these documents, we shall therefore designate by “A method for obtaining a polymer with a controlled structure or architecture”, a method that enables the person skilled in the art to obtain a particular structure for the polymer that he wishes to prepare (such as block, comb, alternating, random, etc.).

By way of example, the person skilled in the art thus knows the documents WO 01/44388 and WO 01/44376 which describe a mineral dispersion containing water, a pigment, and a dispersant obtained by a controlled free radical polymerization method. The dispersant is a polymer having the structure of a comb with a hydrophobic skeleton and hydrophilic pendant groups. The two documents differ in the choice of the polymerization initiator: a compound containing a halide group (WO 01/44388) or a compound selected from the polyethers, polyesters, or polyurethanes (WO 01/44376).

As to the patent U.S. Pat. No. 4,656,226, it relates to a dispersant for pigments obtained by the GTP (Group Transfer Polymerization) technique, having a block structure of the type AB, where A is a segment consisting of polymerized methacrylic monomeric units and B is a segment consisting of polymerized methacrylic or acrylic monomeric units.

At this stage of the search, the aim of the person skilled in the art is therefore to obtain such polymers with a controlled architecture.

Pursuing his searches in this direction, the person skilled in the art then gains knowledge of the documents presenting the synthesis of controlled structure polymers, obtained by the ATRP (Atom Transfer Radical Polymerization) method. This technique has been extensively described in the document (Controlled Radical Polymerization, K.Matyjaszewski, Am.Chem.Soc., 1998, Chap16, pp258).

Thus, the patent FR 2 797 633 describes a method for polymerizing acrylic and methacrylic monomers by ATRP. Similarly, “First example of the ATRP of an acidic monomer: direct synthesis of methacrylic acid copolymers in aqueous media” (Chem. Commun., 1999, 1285-1286) describes the use of this polymerization method applied to the synthesis of poly(ethylene oxide-sodium methacrylate) block copolymers.

Finally, document WO 00/40630 describes a composition containing an organic or inorganic pigment and a dispersant in the form of a block copolymer obtained by said technique.

However, all of these documents reveal new problems facing the person skilled in the art. On the one hand, the ATRP method employs catalysts based on copper salts which generate undesirable pollution; the copper is also found in the synthesized products, which is not necessarily the aim of the person skilled in the art. On the other hand, the ATRP method also involves amines that are often undesirable in the end product.

Faced with this serious drawback, the person skilled in the art accordingly turns to another polymerization method for obtaining controlled structures: the RAFT (Reversible Addition Fragmentation chain Transfer) technique. This technique has been extensively described in the document (Controlled/Living Radical Polymerization-Progress in ATRP, NMP, and RAFT, K. Matyjaszewski, Am.Chem.Soc., 2000, Chap20, pp278).

In this field, the person skilled in the art knows the document WO 98/01478 which describes the synthesis of polymers of the block, graft or star type, employing a transfer agent of the R—C(═S)—S—R′ type.

At the same time, he knows the patent FR 2 821 620 which proposes a method of the RAFT type for polymerizing acrylic acid, employing a transfer agent of the R—X—C(═S)—S—R′ type. The polymer obtained can then be used as a dispersant or grinding aid agent in suspensions of mineral matter.

Yet a new problem, inherent in this polymerization technique, then appears: the use of sulfur bearing transfer agents. Apart from the drawback of being dangerous to the environment, these transfer agents impart a very unpleasant smell to the polymers obtained, and introduce not necessarily desirable organosulfur compounds into the end product.

To circumvent this new drawback, the person skilled in the art finally turns to the recent controlled free radical polymerization techniques, which employ nitroxides or alkoxyamines as polymerization initiators.

Thus the document WO 00/71501 teaches him that particular polyalkoxyaminees can be used to synthesize triblock copolymers in particular, each block being produced from monomers as different as alkyl acrylates and styrene derivatives, with excellent control of the polymerization and of the polydispersity index. However, this document does not reveal any particular use of said polymers.

Finally, the document WO 01/02345 teaches the person skilled in the art that polyalkoxyamines are suitable for obtaining controlled structure polymers such as block, comb, graft, or indeed random. These polymers have numerous applications as rheology modifiers or dispersants of mineral fillers in aqueous phase. However, this patent application reveals a serious drawback as regards the industrial manufacture of polymers. While it states in the text that the splitting of the O—C bond of the alkoxyamine selected takes place between 50 and 160° C. (page 35), it clearly appears in the examples that the operations must be conducted at temperatures substantially above 100° C. in order to be effective.

As demonstrated by examples C1 to C9 (pages 57 to 59) on the polymerization of butyl acrylate, the reaction must be carried out at 145° C. for 3 hours. In fact, in order to work in aqueous phase, as desired by the person skilled in the art to respect the environment, such temperatures make the polymerization method at atmospheric pressure impossible. Moreover, the fact of having to work at a such high temperatures is a prohibitive drawback for the synthesis of dispersants and grinding aid agents from acrylic compounds; this is because at such temperatures, operations take place near or indeed above the boiling points of the monomers used, these boiling points being 145° C., 141° C. and 161° C. respectively for butyl acrylate, acrylic acid and methacrylic acid.

Furthermore, at such temperatures, thermal initiation mechanisms occur, generating uncontrolled chains and commensurately degrinding the controlled architecture.

Pursuing his researches, the Applicant has surprisingly found the solution to the problem of obtaining stable aqueous suspensions of mineral matter employing controlled structure polymers presenting neither the pollution problems of the polymers produced by the use of copper based compounds, nor the problems of smell of the polymers obtained by the use of sulfur based compounds, nor the problems of pollution incurred by the incorporation of organosulfur compounds.

Thus the Applicant has surprisingly found that water soluble polymers with a controlled structure obtained by a controlled free radical polymerization method, at low temperature, that is at a temperature below the boiling point of the monomers employed and of water, are suitable for obtaining polymers used very effectively as dispersants and/or grinding aid agents for pigments and/or mineral fillers in aqueous suspension.

This polymerization method employs, as a polymerization initiator, a particular alkoxyamine with the general formula (A): 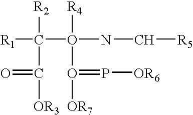
where:
R₁ and R₂ represent a linear or branched alkyl radical, with 1 to 5 carbon atom and preferably represents the methyl radical,
R₃ is a hydrogen atom, a linear or branched alkyl radical with 1 to 8 carbon atoms, a phenyl radical, a cation such as Li⁺, Na⁺, K⁺, H₄N⁺, Bu₃HN⁺ with Bu=butyl and preferably represents the hydrogen atom,
R₄ is a linear or branched alkyl radical with 1 to 8 carbon atoms, and preferably a tertbutyl radical,
R₅ is a linear or branched alkyl radical with 1 to 8 carbon atoms, and preferably a tertbutyl radical,
R₆ and R₇ represent a linear or branched alkyl radical with 1 to 8 carbon atoms, and preferably an ethyl radical.

The polymers thus obtained by the method present the advantage of not containing compounds based on copper salts contrary to the polymers obtained by ATRP, and of not containing sulfur compounds as opposed to the products obtained by the RAFT technique, while having an architecture controllable via their polymerization method.

The finished products obtained are also polymers usable upon completion of the polymerization reaction directly resulting from this polymerization without any need to carry out post-treatment reactions after polymerization such as filtration, precipitation or other, reactions that change the conformation of the resulting polymer.

The object of the invention is therefore the use, as dispersant and/or grinding aid agent for pigments and/or mineral fillers in aqueous suspension, of a water soluble polymer with a controlled structure obtained by a controlled free radical polymerization method employing, as a polymerization initiator, a particular alkoxyamine with the general formula (A).

A further object of the invention resides in the aqueous dispersions and suspensions of pigments and/or mineral fillers thereby obtained.

A further object of the invention is the use of the aqueous dispersions and suspensions of pigments and/or mineral fillers thereby obtained in the paper field such as in particular the coating that employs a formulation of coating colours and the filling in the manufacture of paper sheets, water based paints, plastics, cements, ceramics, detergents, cosmetics, and drilling muds.

A further object of the invention is the paper formulations, water based paints, plastic compositions, cements, ceramic compositions, detergent compositions, cosmetic compositions, and drilling muds thereby obtained.

A further object of the invention is the direct use of said water soluble homopolymers and/or copolymers in the paper formulations, water based paints, cements, ceramic compositions, detergent compositions, cosmetic compositions, and drilling muds, as a dispersant.

A final object of the invention resides in the paper formulations, water based paints, cements, ceramic compositions, detergent compositions, cosmetic compositions, and drilling muds, obtained by the direct use of said polymers as a dispersant.

The use of said water soluble polymers according to the invention therefore makes it possible to obtain stable aqueous dispersions of pigments and/or mineral fillers and finely ground aqueous suspensions of pigments and/or mineral fillers.

These aqueous dispersions and suspensions of pigments and/or mineral fillers are suitable for obtaining paper formulations, water based paints, plastic compositions, cements, ceramic compositions, detergent compositions, cosmetic compositions and drilling muds, the viscosity of which can be controlled according to the final intended application.

Finally, the direct use of said water soluble polymers is suitable for obtaining paper formulations, water based paints, cements, ceramic compositions, detergent compositions, cosmetic compositions and drilling muds, the viscosity of which can also be regulated according to the final intended application.

These objectives are achieved thanks to the use of a water soluble polymer according to the invention, which is characterized in that said polymer has a controlled structure and is obtained by a controlled free radical polymerization method that employs, as a polymerization initiator, a particular alkoxyamine with the general formula (A).

The use of a water soluble polymer according to the invention is further characterized in that the water soluble polymer is obtained by a controlled free radical polymerization method, involving the particular alkoxyamine previously described, of monomers selected from:
a) At least one ionic monomer, which is either
   i) anionic and with a carboxylic or dicarboxylic or phosphoric or phosphonic or sulfonic function or mixture thereof, or
   ii) cationic, or
   iii) the mixture of i) and ii)
b) and possibly at least one nonionic monomer, the nonionic monomer consisting of at least one monomer with the formula (I): 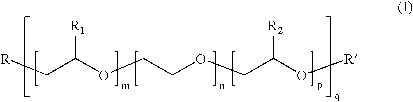
where:
   m and p represent a number of alkylene oxide motifs less than or equal to 150,
   n is a number of ethylene oxide motifs less than or equal to 150,
   q is a whole number at least equal to 1 and such that 5≦(m+n+p)q≦150, and preferably such that 15≦(m+n+p)q≦120,
   R₁ is the hydrogen or the methyl or ethyl radical,
   R₂ is the hydrogen or the methyl or ethyl radical,
   R is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
   R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (I),
c) and possibly at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer or mixtures thereof,
d) and possibly at least one monomer with at least two ethylene unsaturations, referred to in the rest of the application as cross-linking monomer, or the mixture of a plurality of these monomers.

In a particular manner, the use of a water soluble polymer according to the invention is further characterized in that said water soluble polymer is obtained by the controlled free radical polymerization of monomers selected from:
a) at least one ionic monomer which is either
   i) anionic with ethylenic unsaturation and with a monocarboxylic function in the acidic or salified state selected from monomers with ethylenic unsaturation and with monocarboxylic function such as acrylic or methacrylic acid or diacid hemiesters such as the C₁ to C₄ monoesters of maleic or itaconic acids, or selected from the monomers with ethylenic unsaturation and dicarboxylic function in the acidic or salified state such as crotonic, isocrotonic, cinnamic, itaconic, maleic acid, or carboxylic acid anhydrides, such as maleic anhydride, or selected from monomers with ethylenic unsaturation and with a sulfonic function in the acidic or salified state such as acrylamido-methyl-propane-sulfonic acid, sodium methallylsulfonate, vinyl sulfonic acid and styrene sulfonic acid, or even selected from monomers with ethylenic unsaturation and with phosphoric function in the acidic or salified state such as vinyl phosphoric acid, ethylene glycol methacrylate phosphate, propylene glycol methacrylate phosphate, ethylene glycol acrylate phosphate, propylene glycol acrylate phosphate and ethoxylates thereof or even selected from monomers with ethylenic unsaturation and with phosphonic function in the acidic or salified state such as vinyl phosphonic acid or mixtures thereof, or
   ii) cationic selected from N-[3-(dimethylamino)propyl]acrylamide or N-[3-(dimethylamino)propyl]methacrylamide, unsaturated esters such as N-[2-(dimethylamino)ethyl]methacrylate, or N-[2-(dimethylamino)ethyl]acrylate, or from quaternary ammoniums such as [2-(methacryloyloxy)ethyl]trimethyl ammonium chloride or sulfate, [2-(acryloyloxy)ethyl]trimethyl ammonium chloride or sulfate, [3-(acrylamido)propyl]trimethyl ammonium chloride or sulfate, dimethyl diallyl ammonium chloride or sulfate, [3-(methacrylamido)propyl]trimethyl ammonium chloride or sulfate, or mixtures thereof, or
   iii) the mixture of the above anionic and cationic monomers
b) and possibly at least one monomer with nonionic ethylenic unsaturation with the formula (I): 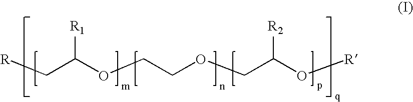
where:
   m and p represent a number of alkylene oxide motifs less than or equal to 150,
   n is a number of ethylene oxide motifs less than or equal to 150,
   q is a whole number at least equal to 1 and such that 5≦(m+n+p)q≦150, and preferably such that 15≦(m+n+p)q≦120,
   R₁ is the hydrogen or the methyl or ethyl radical,
   R₂ is the hydrogen or the methyl or ethyl radical,
   R is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
   R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (I),
c) and possibly at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer selected preferably from the molecules with formulas (IIa) or (IIb):
with formula (IIa) 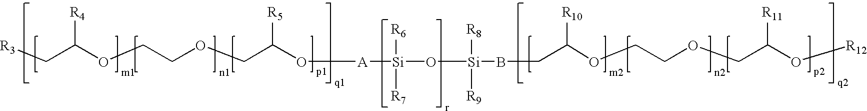
where:
   m1, p1, m2 and p2 represent a number of alkylene oxide motifs less than or equal to 150,
   n1 and n2 represent a number of ethylene oxide motifs less than or equal to 150,
   q2 and q2 represent a whole number at least equal to 1 and such that 0≦(m1+n1+p1)q1≦150 and 0≦(m2+n2+p2)q2≦150,
   r is a number such that 1≦r≦200,
   R₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
   R₄, R₅, R₁₀ and R₁₁, represent hydrogen or the methyl or ethyl radical,
   R₆, R₇, R₈ and R₉, represent linear or branched alkyl, or aryl, or alkylaryl, or arylalkyl groups with 1 to 20 carbon atoms, or mixtures thereof,
   R₁₂ is a hydrocarbon radical with 1 to 40 carbon atoms,
   A and B are groups that may be present, which then represent a hydrocarbon radical with 1 to 4 carbon atoms,
with the formula (IIb)
   R-A-Si(OB)₃
where:
   R is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
   A is a group that may be present, which then represents a hydrocarbon radical with 1 to 4 carbon atoms,
   B is a hydrocarbon radical with 1 to 4 carbon atoms,
      or the mixture of a plurality of these monomers,
d) and possibly at least one cross-linking monomer selected in a non-limiting way from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, allyl ethers obtained from polyols such as pentaerythritol, sorbitol, sucrose, or others or selected from molecules with the formula (III): 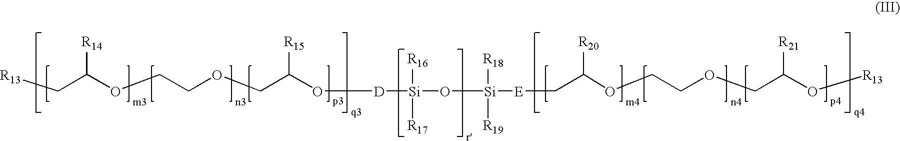
where:
   m3, p3, m4 and p4 represent a number of alkylene oxide motifs less than or equal to 150,
   n3 and n4 represent a number of ethylene oxide motifs less than or equal to 150,
   q3 and q4 represent a whole number at least equal to 1 and such that 0≦(m3+n3+p3)q3≦150 and 0≦(m4+n4+p4)q4≦150,
   r′ is a number such that 1≦r′≦200,
   R₁₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
   R₁₄, R₁₅, R₂₀ and R₂₁, represent hydrogen or the methyl or ethyl radical,
   R₁₆, R₁₇, R₁₈ and R₁₉, represent linear or branched alkyl, or aryl, or alkylaryl, or arylalkyl groups with 1 to 20 carbon atoms, or mixtures thereof,
   D and E are groups that may be present, which then represent a
hydrocarbon radical with 1 to 4 carbon atoms, or the mixture of a plurality of these monomers.

More particularly the use of a water soluble monomer according to the invention is characterized in that said polymer consists of, expressed by weight:
a) 2% to 100% and even more particularly 5% to 100% of at least one ionic monomer, which is either
   i) anionic with ethylenic unsaturation and with a monocarboxylic function in the acidic or salified state selected from monomers with ethylenic unsaturation and with monocarboxylic function such as acrylic or methacrylic acid or diacid hemiesters such as the C₁ to C₄ monoesters of maleic or itaconic acids, or selected from the monomers with ethylenic unsaturation and dicarboxylic function in the acidic or salified state such as crotonic, isocrotonic, cinnamic, itaconic, maleic acid, or carboxylic acid anhydrides, such as maleic anhydride, or selected from monomers with ethylenic unsaturation and with a sulfonic function in the acidic or salified state such as acrylamido-methyl-propane-sulfonic acid, sodium methallylsulfonate, vinyl sulfonic acid and styrene sulfonic acid, or even selected from monomers with ethylenic unsaturation and with phosphoric function in the acidic or salified state such as vinyl phosphoric acid, ethylene glycol methacrylate phosphate, propylene glycol methacrylate phosphate, ethylene glycol acrylate phosphate, propylene glycol acrylate phosphate and ethoxylates thereof or even selected from monomers with ethylenic unsaturation and with phosphonic function in the acidic or salified state such as vinyl phosphonic acid or mixtures thereof, or
   ii) cationic selected from N-[3-(dimethylamino)propyl]acrylamide or N-[3-(dimethylamino)propyl]methacrylamide, unsaturated esters such as N-[2-(dimethylamino)ethyl]methacrylate, or N-[2-(dimethylamino)ethyl]acrylate, or from quaternary ammoniums such as [2-(methacryloyloxy)ethyl]trimethyl ammonium chloride or sulfate, [2-(acryloyloxy)ethyl]trimethyl ammonium chloride or sulfate, [3-(acrylamido)propyl]trimethyl ammonium chloride or sulfate, dimethyl diallyl ammonium chloride or sulfate, [3-(methacrylamido)propyl]trimethyl ammonium chloride or sulfate, or mixtures thereof, or
   iii) a mixture of the above anionic and cationic monomers,
b) 0 to 98% and even or particularly 0% to 96% of at least one monomer with nonionic ethylenic unsaturation with the formula (I): 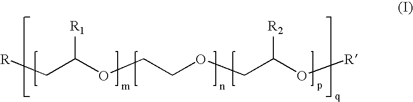
where:
   m and p represent a number of alkylene oxide motifs less than or equal to 150,
   n is a number of ethylene oxide motifs less than or equal to 150,
   q is a whole number at least equal to 1 and such that 5≦(m+n+p)q≦150, and preferably such that 15≦(m+n+p)q≦120,
   R₁ is the hydrogen or the methyl or ethyl radical,
   R₂ is the hydrogen or the methyl or ethyl radical,
   R is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
   R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (I),
c) 0% to 50% of at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer selected preferably from the molecules with formulas (IIa) or (IIb):
with formula (IIa) 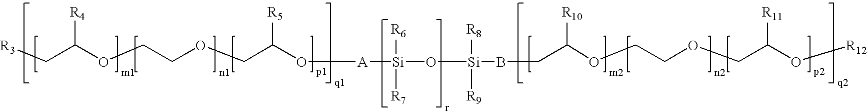
where:
   m1, p1, m2 and p2 represent a number of alkylene oxide motifs less than or equal to 150,
   n1 and n2 represent a number of ethylene oxide motifs less than or equal to 150,
   q1 and q2 represent a whole number at least equal to 1 and such that 0≦(m1+n1+p1)q1≦150 and 0≦(m2+n2+p2)q2≦150,
   r is a number such that 1≦r≦200,
   R₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
   R₄, R₅, R₁₀ and R₁₁, represent hydrogen or the methyl or ethyl radical,
   R₆, R₇, R₈ and R₉, represent linear or branched alkyl, or aryl, or alkylaryl, or arylalkyl groups with 1 to 20 carbon atoms, or mixtures thereof,
   R₁₂ is a hydrocarbon radical with 1 to 40 carbon atoms,
   A and B are groups that may be present, which then represent a hydrocarbon radical with 1 to 4 carbon atoms,
with the formula (IIb)
   R-A-Si(OB)₃
where:
   R is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
   A is a group that may be present, which then represents a hydrocarbon radical with 1 to 4 carbon atoms,
   B is a hydrocarbon radical with 1 to 4 carbon atoms,
or the mixture of a plurality of these monomers,
d) 0 to 3% of at least one cross-linking monomer selected in a non-limiting way from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, allyl ethers obtained from polyols such as pentaerythritol, sorbitol, sucrose, or others, or selected from molecules with the formula (III): 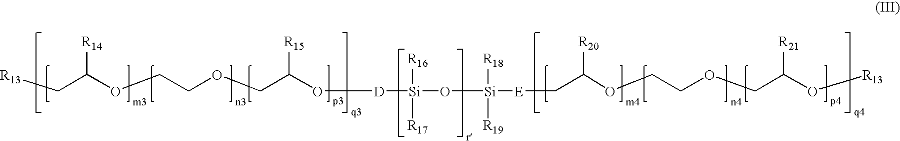
where:
   m3, p3, m4 and p4 represent a number of alkylene oxide motifs less than or equal to 150,
   n3 and n4 represent a number of ethylene oxide motifs less than or equal to 150,
   q3 and q4 represent a whole number at least equal to 1 and such that 0≦(m3+n3+p3)q3≦150 and 0≦(m4+n4+p4)q4≦150,
   r′ is a number such that 1≦r′≦200,
   R₁₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
   R₁₄, R₁₅, R₂₀ and R₂₁, represent hydrogen or the methyl or ethyl radical,
   R₁₆, R₁₇, R₁₈ and R₁₉, represent linear or branched alkyl, or aryl, or alkylaryl, or arylalkyl groups with 1 to 20 carbon atoms, or mixtures thereof,
   D and E are groups that may be present, which then represent a hydrocarbon radical with 1 to 4 carbon atoms,
      or the mixture of a plurality of these monomers.

Finally, the use of a water soluble polymer according to the invention is characterized in that said polymer is a water soluble copolymer and has a random, block, comb, graft, or alternating type of structure.

Depending on its use, the person skilled in the art will know how to adjust the molecular weight of the polymer employed according to the invention.

This molecular weight is determined by the GPC (Gel Permeability Chromatography) method using a Waters™ liquid chromatograph equipped with two detectors of which one combines the dynamic diffusion of light with viscometry measured by a Viscotek™ viscometer and the other is a Waters™ refractometric concentration detector.

This liquid chromatograph is equipped with steric hindrance columns suitably selected by the person skilled in the art in order to separate the different molecular weights of the polymers analyzed.

The liquid elution phase is an aqueous phase.

A further object of the invention resides in the dispersants and/or grinding aid agents for mineral matter in aqueous suspension.

Thus the dispersant of mineral matter in aqueous suspension according to the invention is characterized in that the polymer is a water soluble polymer having a controlled structure and obtained by a controlled free radical polymerization method employing, as a polymerization initiator, an alkoxyamine with the general formula (A) previously defined.

It is preferably characterized in that the water soluble polymer is obtained by the controlled free radical polymerization of monomers selected from the monomers previously discussed.

Another particular manner consists in that the dispersant according to the invention is characterized in that it is a water soluble copolymer and in that it has a random, block, comb, graft or alternating structure.

Similarly, the grinding aid agent for mineral matter according to the invention is characterized in that the polymer is a water soluble polymer having a controlled structure and obtained by a controlled free radical polymerization method employing, as a polymerization initiator, an alkoxyamine with the general formula (A) previously defined.

It is preferably characterized in that the water soluble polymer is obtained by the controlled free radical polymerization of monomers selected from the monomers previously discussed.

Another particular manner consists in that the grinding aid agent according to the invention is characterized in that it is a water soluble copolymer and in that is has a random, block, comb, graft, or alternating structure.

A further object of the invention resides in the method for dispersing and the method for grinding mineral matter in aqueous suspension.

The method for dispersing mineral matter according to the invention is characterized in that the water soluble polymer according to the invention is used and particularly in that 0.05% to 5% by dry weight of said polymer is used with respect to the dry weight of pigment and/or mineral filler, and very preferably between 0.1% and 3% of said polymer with respect to the dry weight of pigment and/or mineral filler.

The method for grinding mineral matter according to the invention is characterized in that the water soluble polymer according to the invention is used and particularly in that 0.05% to 5% by dry weight of said polymer is used with respect to the dry weight of pigment and/or mineral filler, and very preferably between 0.1% and 3% of said polymer with respect to the dry weight of pigment and/or mineral filler.

Finally, a further object of the invention resides in the aqueous dispersions and suspensions of pigments and/or mineral fillers obtained thanks to the use of the above water soluble polymer according to the invention.

These aqueous dispersions of mineral matter are characterized in that they contain a pigment and/or a mineral filler selected from natural or synthetic calcium carbonate, dolomites, kaolonite, talc, gypsum, lime, magnesia, titanium oxide, satin white, aluminum trioxide or even aluminum trihydroxide, silicas, mica and the mixture of these fillers together, such as the talc-calcium carbonate, calcium carbonate-kaolinite mixtures, or even mixtures of calcium carbonate with aluminum trihydroxide or aluminum trioxide, or even mixtures with synthetic or natural fibers or even co-structures of minerals such as the talc-calcium carbonate or talc-titanium dioxide co-structures or mixtures thereof.

These aqueous suspensions of mineral matter are characterized in that they contain a pigment and/or a mineral filler selected from natural or synthetic calcium carbonate, dolomites, kaolonite, talc, gypsum, lime, magnesia, titanium oxide, satin white, aluminum trioxide or even aluminum trihydroxide, silicas, mica and the mixture of these fillers together, such as the talc-calcium carbonate, calcium carbonate-kaolinite mixtures, or even mixtures of calcium carbonate with aluminum trihydroxide or aluminum trioxide, or even mixtures with synthetic or natural fibers or even co-structures of minerals such as the talc-calcium carbonate or talc-titanium dioxide co-structures or mixtures thereof.

The aqueous dispersions according to the invention are characterized in that they contain in a particular manner natural or synthetic calcium carbonate and more particularly a natural calcium carbonate selected from marble, calcite, chalk or mixtures thereof.

The aqueous suspensions according to the invention are characterized in that they contain in a particular manner natural or synthetic calcium carbonate and more particularly a natural calcium carbonate selected from marble, calcite, chalk or mixtures thereof.

Finally, the above aqueous suspensions and dispersions are characterized in that they contain 0.05 to 5% by dry weight of the water soluble polymer used according to the invention with respect to the dry weight of the pigments and/or mineral fillers, and in that they contain more particularly 0.1 to 3% by dry weight of the water soluble polymer used according to the invention with respect to the dry weight of the pigment and/or mineral fillers.

A further object of the invention is the use of the aqueous dispersions and suspensions of pigments and/or mineral fillers thus obtained in the paper field such as in particular the coating of the paper putting into practice a formulation of coating colours and the filling of the paper in the manufacture of paper sheets, water based paints, plastics, cement, ceramics, detergents, drilling muds.

A further object of the invention is a method for dispersing mineral matter in a paper formulation, in a water based paint, in a cement, in a ceramic composition, in a detergent composition, in a drilling mud. This method is accordingly characterized in that the water soluble polymer according to the invention is used directly as dispersant.

A further object of the invention resides in the paper formulations, water based paints, plastic composition, cements, ceramic compositions, detergent compositions, cosmetic compositions and drilling muds obtained from said above aqueous dispersions and suspensions of pigments and/or mineral fillers.

A further object of the invention is the direct use of the polymer according to the invention as dispersant in the paper formulations, water based paints, cements, ceramic compositions, detergent compositions, cosmetic compositions and drilling muds.

A final object of the invention resides in the paper formulations, water based paints, cements, ceramic compositions, detergent compositions, cosmetic compositions and drilling muds thus obtained.

Regardless of the method for obtaining them (using the aqueous dispersions and/or suspensions of mineral matter made with said polymer and/or said copolymer, or by direct introduction of said polymer and/or said copolymer in the formulations concerned) the paper formulations, water based paints, plastic compositions, cements, ceramic compositions, detergent compositions, cosmetic compositions and drilling muds, are characterized in that they contain 0.01% to 5% by dry weights of said water soluble polymer.

The scope and advantages of the invention will be better understood from the following examples which are non-limiting.

### EXAMPLE 1

This example illustrates the obtaining of water soluble polymers put into practice according to the invention.

Test No. 1:

The following are introduced into a 1 liter glass reactor equipped with mechanical stirring and an oil bath type of heating system:
10.56 g of methacrylic acid
200 g of water
490 g of an aqueous solution containing 50% by weight of molecular weight 5000 polyethylene glycol methoxy methacrylate.

The medium is heated to 55° C. and a solution is introduced in one step consisting of 25 g of ethanol and 2.92 g of the following alkoxyamine:

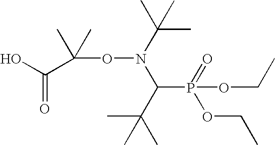

The mixture is heated for 2 hours with stirring at 60° C. and the ethanol is distilled. The medium is neutralized to pH 7 with 50% caustic soda solution.

A clear aqueous solution is obtained containing 37% of dry matter of a polymer consisting by weight of:
4.13% of methacrylic acid,
95.87% of molecular weight 5000 polyethylene glycol methoxy methacrylate of which the GPC analysis previously described indicates a weight average molecular weight of 169000.
   Test No. 2

The following are introduced into a 1 liter glass reactor equipped with mechanical stirring and an oil bath type of heating system:
10.56 g of methacrylic acid
200 g of water
490 g of an aqueous solution containing 50% by weight of molecular weight 5000 polyethylene glycol methoxy methacrylate.

The medium is heated to 65° C. and a solution is introduced in one step consisting of 25 g of ethanol and 2.92 g of the following alkoxyamine:

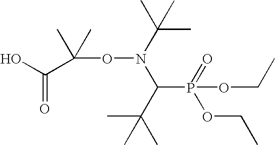

The mixture is heated for 2 hours with stirring at 70° C. and the ethanol is distilled. The medium is neutralized to pH 7 with 50% caustic soda solution.

A clear aqueous solution is obtained containing 36% of dry matter of a polymer consisting by weight of:
4.13% of methacrylic acid,
95.87% of molecular weight 5000 polyethylene glycol methoxy methacrylate of which the GPC analysis previously described indicates a weight average molecular weight of 103000.
   Test No. 3

The following are introduced into a 1 liter glass reactor equipped with mechanical stirring and an oil bath type of heating system:
16.9 g of methacrylic acid
200 g of water
490 g of an aqueous solution containing 50% by weight of molecular weight 2000 polyethylene glycol methoxy methacrylate.

The medium is heated to 65° C. and a solution is introduced in one step consisting of 25 g of ethanol and 2.92 g of the following alkoxyamine:

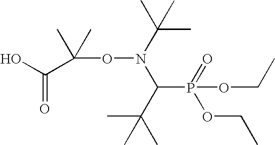

The mixture is heated for 2 hours with stirring at 70° C. and the ethanol is distilled. The medium is neutralized to pH 7 with 50% caustic soda solution.

A clear aqueous solution is obtained containing 39% of dry matter of a polymer consisting by weight of:
6.45% of methacrylic acid,
93.55% of molecular weight 2000 polyethylene glycol methoxy methacrylate of which the GPC analysis previously described indicates a weight average molecular weight of 85000.
   Test No. 4

The following are introduced into a 1 liter glass reactor equipped with mechanical stirring and an oil bath type of heating system:
10.56 g of methacrylic acid
200 g of water
490 g of an aqueous solution containing 50% by weight of molecular weight 1100 polyethylene glycol methoxy methacrylate.

The medium is heated to 65° C. and a solution is introduced in one step consisting of 25 g of ethanol and 2.92 g of the following alkoxyamine:

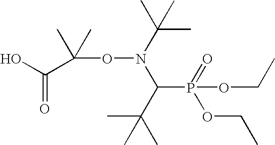

The mixture is heated for 2 hours with stirring at 70° C. and the ethanol is distilled. The medium is neutralized to pH 7 with 50% caustic soda solution.

A clear aqueous solution is obtained containing 40% of dry matter of a polymer consisting by weight of:
4.13% of methacrylic acid,
95.87% of molecular weight 1100 polyethylene glycol methoxy methacrylate of which the GPC analysis previously described indicates a weight average molecular weight of 129000.

### EXAMPLE 2

This example illustrates the putting into practice of the polymers obtained according to the invention as a grinding aid for mineral matter and more particularly for calcium carbonate. This example also illustrates the obtaining of an aqueous suspension of calcium carbonate according to the invention.

It should also be noted that these suspensions of calcium carbonate according to the invention are refined, strongly concentrated in mineral matter and easy to handle by the end user that is easily usable for paper coating and for paper filling.

Test No. 5:

This test, which illustrates the invention, puts into practice 1.2% by dry weight of the polymer of test No. 1, with respect to the dry weight of calcium carbonate.

Test No. 6:

This test, which illustrates the invention, puts into practice 1.2% by dry weight of the polymer of test No. 2, with respect to the dry weight of calcium carbonate.

Test No. 7:

This test, which illustrates the invention, puts into practice 1.2% by dry weight of the polymer of test No. 3, with respect to the dry weight of calcium carbonate.

Test No. 8:

This test, which illustrates the invention, puts into practice 1.2% by dry weight of the polymer of test No. 4, with respect to the dry weight of calcium carbonate.

For each test, an aqueous suspension was prepared using calcium carbonate from the Orgon deposit (France), with an average particle diameter of about 50 microns.

The aqueous suspension has a dry matter concentration of 78% by weight with respect to the total weight.

The grinding aid agent is introduced into this suspension according to the indicated quantities, expressed as percent by dry weight with respect to the weight of dry calcium carbonate to be ground.

The suspension circulates in a Dyno-Mill™ type of grinder with a fixed cylinder and a rotating impeller, of which the grinding material consists of corundum beads between 0.6 millimeter and 1.0 millimeter in diameter.

The total occupied by the grinding material is 1150 cubic centimeters whereas its weight is 2900 g.

The grinding chamber has a volume of 1400 cubic centimeters.

The circumferential speed of the grinder is 10 meters per second.

The calcium carbonate suspension is recycled at the rate of 18 liters per hour.

The outlet of the Dyno-Mill™ grinder is equipped with a 200 micron mesh separator to separate the suspension produced by the grinding from the grinding material.

The temperature during each grinding test is kept at about 60° C.

At the end of grinding (Tₒ), a sample of the pigment suspension is recovered in a bottle. The particle size distribution of this suspension (% of particles under one micron) is measured using a Sedigraph™ 5100 granulometer manufactured by Micromeritics.

The Brookfield™ viscosity of the suspensions is measured using an RVT type Brookfield™ viscometer, at a temperature of 20° C. and speeds of rotation of 10 r.p.m. and 100 r.p.m. with the appropriate mobile element. The results represent the viscosity values at t=0.

After being left to rest for 8 days in the bottle, the bottle is shaken and the viscosity of the suspension is measured by introducing the appropriate spindle of the RVT type Brookfield™ viscometer into the bottle, at a temperature of 20° C. and speeds of rotation of 10 r.p.m. and 100 r.p.m.

These viscosity measurements represents the APAG viscosity results at t=8 days after stirring.

All this experimental results are given in Table 1 below, which also indicates the consumption in percentage by weight of grinding aid agent used to obtain the indicated particle size distribution

TABLE 1

| | | Brookfield ™ | | Brookfield ™ Viscosities | |
|---|---|---|---|---|---|
| | Particle Size | Viscosities (mPa · s) at | | (mPa · s) at t = 8 d after | |
| Test | Distribution | t = 0 | | stirring | |
| No. | % < 1 μm | μ₁₀ | μ₁₀₀ | μ₁₀ | μ₁₀₀ |
| 5 | 58.8 | 3160 | 1220 | 5440 | 2180 |
| 6 | 57.2 | 2680 | 1025 | 4060 | 1000 |
| 7 | 56.8 | 3080 | 1020 | 2600 | 970 |
| 8 | 57.0 | 4480 | 1380 | 2940 | 1000 |

A reading of the results of Table 1 shows that the polymers according to the invention can be used as grinding aids for mineral matter in aqueous suspension, and in particular natural calcium carbonate, and that it is also possible to obtain aqueous suspensions of natural calcium carbonate containing the polymer according to the invention.

### EXAMPLE 3

This example concerns the demonstration of the use of the polymers according to the invention as cement dispersants. This example also illustrates the obtaining of the aqueous suspension of cement according to the invention.

For this purpose, for each of the tests of the example, the various components of the standard grout are poured into a grout mixer (EN 196-1) in the On position, with a real constant volume of 1 m³ per 450 kg of cement and of constant workability equal to 2 seconds measured on the Perrier worksite grout workability meter defined by standard NFP 18452.

For this purpose, the following are weighed in the bowl of the mixer:
450 g of CCB 42.5R HES Gaurain cement according to standard NF P 15-301;
the necessary quantity of water;
0.5% by dry weight of the dispersant to be tested, with respect to the weight of cement;
a variable quantity in grams of Leucate standard sand (EN 196-1). This quantity of sand being added according to standard EN 196-1 during 30 seconds and after 30 seconds of slow stirring of the mixture of components previously added.

After the end of the addition of these various components, the mixer is maintained at high speed for 30 seconds and then stopped for 90 seconds to scrape the walls of the mixer.

Once the grout adhering to the walls has been completely scraped off, the mixing is resumed for one minute at high speed.

Compliance with these time intervals enables us to obtain a mixing cycle that lasts 4 minutes and conforms to standard EN 196-1.

Test No. 9:

This test illustrates the control and puts into practice a cement formulation without additive.

Test No. 10:

This test illustrates the prior art and puts into practice a naphthalene sulfonate commercialised by Scheppens.

Test No. 11:

This test, which illustrates the invention, puts into practice the polymer of test No. 1.

Test No. 12:

This test, which illustrates the invention, puts into practice the polymer of test No. 3.

Test No. 13:

This test, which illustrates the invention, puts into practice the polymer of test No. 4.

Test No. 14:

This test, which illustrates the invention, puts into practice the polymer of test No. 2.

The quantities of components being adjusted for each of the grouts of the various tests in order to operate at a constant real volume (1 m³ per 450 kg of cement) and constant workability (2 seconds), the polymer put into practice is even more effective with less water and more sand.

The results obtained for the different tests are given in Table 2 below.

TABLE 2

| | | Prior | | | | Inven- |
|---|---|---|---|---|---|---|
| | Control | Art | Invention | Invention | Invention | tion |
| Test No. | 9 | 10 | 11 | 12 | 13 | 14 |
| Cement | 450 | 450 | 450 | 450 | 450 | 450 |
| (g) | | | | | | |
| Sand | 1596 | 1610 | 1635 | 1620 | 1625 | 1620 |
| (g) | | | | | | |
| Water | 248 | 225 | 210 | 200 | 200 | 200 |
| (g) | | | | | | |

A reading of the table reveals the improvement provided by the use of the copolymers according to the invention as cement dispersants.

### EXAMPLE 4

This example concerns the use of the polymers according to the invention in the field of ceramics.

For this purpose, the dispersant efficiency is evaluated of the polymers according to the invention contained in the aqueous suspensions of clay according to the invention put into practice in the field of ceramics.

For this purpose, and for each of the tests Nos. 16 to 19, 250 grams of raw water and 0.65 grams of dispersant to be tested are weighed in a 500 milliliter plastic beaker fitted with a stirring rod 60 mm in diameter.

After stirring the mixture contained in the beaker, 217.3 g of Fuchs-Ton clay for slurry, is poured in, in order to obtain a dry matter concentration of 46.5% and a test dispersant content of 0.3% by dry weight with respect to the dry weight of clay.

After 20 minutes of stirring at a speed of 750 r.p.m., the viscosity of the slurry is measured by measuring the RVT type Brookfield™ viscosity at 10 r.p.m. and 100 r.p.m.

The various tests are as follows:

Test No. 15:

This test is a control and uses no dispersant.

The Brookfield™ viscosities obtained are 6400 mPa·s at 10 r.p.m. and 870 mPa·s at 100 r.p.m.

Test No. 16

This test illustrates the use of polymer according to the invention and puts into practice the polymer of test No. 1.

The Brookfield™ viscosities obtained are 6000 mPa·s at 10 r.p.m. and 800 mPa·s at 100 r.p.m.

Test No. 17:

This test illustrates the use of polymer according to the invention and puts into practice the polymer of test No.4.

The Brookfield™ viscosities obtained are 6000 mPa·s at 10 r.p.m. and 800 mPa·s at 100 r.p.m.

Test No. 18:

This test illustrates the use of polymer according to the invention and puts into practice the polymer of test No.2.

The Brookfield™ viscosities obtained are 6000 mPa·s at 10 r.p.m. and 800 mPa·s at 100 r.p.m.

Test No. 19:

This test illustrates the use of polymer according to the invention and puts into practice the polymer of test No. 3.

The Brookfield™ viscosities obtained are 6000 mPa·s at 10 r.p.m. and 800 mPa·s at 100 r.p.m.

A reading of the results of the various tests shows that the use of the polymers in the field of ceramics is feasible.

### EXAMPLE 5

This example illustrates the obtaining of water soluble polymers put into practice according to the invention.

Test No. 20

The following are introduced into a 1 liter glass reactor equipped with mechanical stirring and an oil bath type of heating system:
13.03 g methacrylic acid
233 g water
425.46 g of an aqueous solution containing 50% by weight of molecular weight 2000 polyethylene glycol methoxy methacrylate,
3.3 g butoxypoly(oxyethylene oxypropylene)methacrylate containing 10 oxyethylene motifs and 11 oxypropylene motifs.

The medium is heated to 95° C. and a solution is introduced progressively, over a period of 2 hours, consisting of 8.8 g of the following alkoxyamine, previously diluted in 50 g water and 2.2 g caustic soda at 50%:

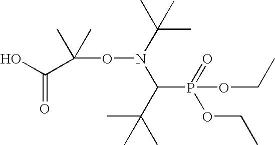

The mixture is then heated for 1 hour with stirring at 95° C.

The medium is neutralized to pH 8 with 50% caustic soda solution.

A clear aqueous solution is obtained containing 30.9% of dry matter of a polymer consisting by weight of:
5.7% methacrylic acid,
92.8% molecular weight 2000 polyethylene glycol methoxy methacrylate,
1.5% butoxypoly(oxyethylene oxypropylene)methacrylate containing 10 oxyethylene motifs and 11 oxypropylene motifs,
   of which the GPC analysis previously described indicates a weight-average molecular weight of 22,870.
   Test No. 21

The following are introduced into a 1 liter glass reactor equipped with mechanical stirring and an oil bath type of heating system:
206.3 g methacrylic acid,
233 g water
22.4 g of an aqueous solution containing 50% by weight of molecular weight 2000 polyethylene glycol methoxy methacrylate,
3.3 g butoxypoly(oxyethylene oxypropylene)methacrylate containing 10 oxyethylene motifs and 11 oxypropylene motifs.

The medium is heated to 95° C. and gradually, over a period of 2 hours, a solution is introduced consisting of 8.8 g of the following alkoxyamine, previously diluted in 50 g water and 2.2 g caustic soda at 50%:

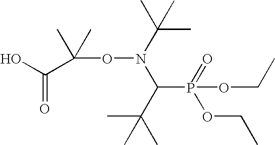

The mixture is then heated for 1 hour with stirring at 95° C.

The medium is neutralized to pH 8 with 50% caustic soda solution.

A clear aqueous solution is obtained containing 32.7% of dry matter of a polymer consisting by weight of:
93.6% methacrylic acid,
4.9% molecular weight 2000 polyethylene glycol methoxy methacrylate,
1.5% butoxypoly(oxyethylene oxypropylene)methacrylate containing 10 oxyethylene motifs and 11 oxypropylene motifs.
   of which the GPC analysis previously described indicates a weight-average molecular weight of 39,130.
   Test No. 22

The following are introduced into a 1 liter glass reactor equipped with mechanical stirring and an oil bath type of heating system:
30.0 g methacrylic acid,
233 g water
363.9 g of an aqueous solution containing 50% by weight of molecular weight 2000 polyethylene glycol methoxy methacrylate,
3.3 g butoxypoly(oxyethylene oxypropylene)methacrylate containing 10 oxyethylene motifs and 11 oxypropylene motifs,
1.1 g ethylene glycol dimethacrylate.

The medium is heated to 95° C. and gradually, over a period of 2 hours, a solution is introduced consisting of 8.8 g of the following alkoxyamine, previously diluted in 50.7 g water and 2.2 g caustic soda at 50%:

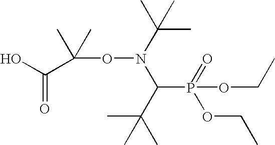

The mixture is then heated for 1 hour with stirring at 95° C.

The medium is neutralized to pH 8 with 50% caustic soda solution.

A clear aqueous solution is obtained containing 32.1% of dry matter of a polymer consisting by weight of:
18.4% methacrylic acid,
79.6% molecular weight 2000 polyethylene glycol methoxy methacrylate,
1.5% butoxypoly(oxyethylene oxypropylene)methacrylate containing 10 oxyethylene motifs and 11 oxypropylene motifs,
0.5% ethylene glycol dimethacrylate,
   of which the GPC analysis previously described indicates a weight-average molecular weight of 40,000.
   Test No. 23

The following are introduced into a 1 liter glass reactor equipped with mechanical stirring and an oil bath type of heating system:
54.0 g methacrylic acid,
270 g water,
655 g of an aqueous solution containing 50% by weight of molecular weight 2000 polyethylene glycol methoxy methacrylate,
5.9 g butoxypoly(oxyethylene oxypropylene)methacrylate containing 10 oxyethylene motifs and 11 oxypropylene motifs.

The medium is heated to 95° C. and gradually, over a period of 2 hours, a solution is introduced consisting of 3.96 g of the following alkoxyamine, previously diluted in 90.2 g water and 1.02 g caustic soda at 50%:

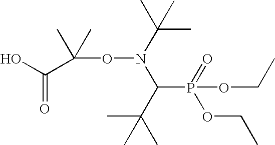

The mixture is then heated for 1 hour with stirring at 95° C.

The medium is neutralized to pH 8 with 50% caustic soda solution.

A clear aqueous solution is obtained containing 34.1% of dry matter of a polymer consisting by weight of:
18.5% methacrylic acid,
80.0% molecular weight 2000 polyethylene glycol methoxy methacrylate,
1.5% butoxypoly(oxyethylene oxypropylene)methacrylate containing 10 oxyethylene motifs and 11 oxypropylene motifs,
   of which the GPC analysis previously described indicates a weight-average molecular weight of 162,400.
   Test No. 24

The following are introduced into a 1 liter glass reactor equipped with mechanical stirring and an oil bath type of heating system:
54.0 g methacrylic acid,
270 g water,
655 g of an aqueous solution containing 50% by weight of molecular weight 2000 polyethylene glycol methoxy methacrylate,
5.9 g butoxypoly(oxyethylene oxypropylene)methacrylate containing 10 oxyethylene motifs and 11 oxypropylene motifs.

The medium is heated to 95° C. and gradually, over a period of 2 hours, a solution is introduced consisting of 7.90 g of the following alkoxyamine, previously diluted in 90.0 g water and 2.03 g caustic soda at 50%:

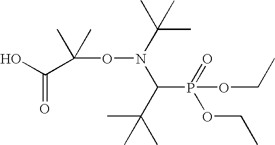

The mixture is then heated for 1 hour with stirring at 95° C.

The medium is neutralized to pH 8 with 50% caustic soda solution.

A clear aqueous solution is obtained containing 34.4% of dry matter of a polymer consisting by weight of:
18.5% methacrylic acid,
80.0% molecular weight 2000 polyethylene glycol methoxy methacrylate,
1.5% butoxypoly(oxyethylene oxypropylene)methacrylate containing 10 oxyethylene motifs and 11 oxypropylene motifs.
   of which the GPC analysis previously described indicates a weight-average molecular weight of 66,100.
   Test No. 25

The following are introduced into a 1 liter glass reactor equipped with mechanical stirring and an oil bath type of heating system:
54.0 g methacrylic acid,
270 g water,
655 g of an aqueous solution containing 50% by weight of molecular weight 2000 polyethylene glycol methoxy methacrylate,
5.9 g butoxypoly(oxyethylene oxypropylene)methacrylate containing 10 oxyethylene motifs and 11 oxypropylene motifs.

The medium is heated to 95° C. and gradually, over a period of 2 hours, a solution is introduced consisting of 15.86 g of the following alkoxyamine, previously diluted in 90.2 g water and 4.03 g caustic soda at 50%:

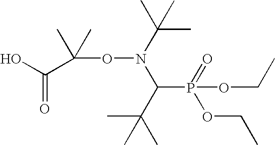

The mixture is then heated for 1 hour with stirring at 95° C.

The medium is neutralized to pH 8 with 50% caustic soda solution.

A clear aqueous solution is obtained containing 34.5% of dry matter of a polymer consisting by weight of:
18.5% methacrylic acid,
80.0% molecular weight 2000 polyethylene glycol methoxy methacrylate,
1.5% butoxypoly(oxyethylene oxypropylene)methacrylate containing 10 oxyethylene motifs and 11 oxypropylene motifs.
   of which the GPC analysis previously described indicates a weight-average molecular weight of 33,300.
   Test No. 26

The following are introduced into a 1 liter glass reactor equipped with mechanical stirring and an oil bath type of heating system:
42.0 g methacrylic acid,
326 g water,
509.5 g of an aqueous solution containing 50% by weight of molecular weight 2000 polyethylene glycol methoxy methacrylate,
4.6 g butoxypoly(oxyethylene oxypropylene)methacrylate containing 10 oxyethylene motifs and 11 oxypropylene motifs,
1.5 g of a silicon monomer formula R-A-Si(OB)₃ where R is the methacrylate group, A is the propyl radical and B is the methyl radical.

The medium is heated to 95° C. and gradually, over a period of 2 hours, a solution is introduced consisting of 12.4 g of the following alkoxyamine, previously diluted in 71.0 g water and 3.15 g caustic soda at 50%:

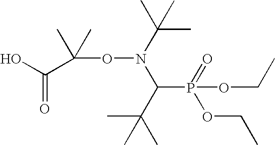

The mixture is then heated for 1 hour with stirring at 95° C.

The medium is neutralized to pH 8 with 50% caustic soda solution.

A clear aqueous solution is obtained containing 30.6% of dry matter of a polymer consisting by weight of:
18.4% methacrylic acid,
79.6% molecular weight 2000 polyethylene glycol methoxy methacrylate,
1.5% butoxypoly(oxyethylene oxypropylene)methacrylate containing 10 oxyethylene motifs and 11 oxypropylene motifs,
0.5% of a silicon monomer formula R-A-Si(OB)₃ where R is the methacrylate group, A is the propyl radical and B is the methyl radical,
   of which the GPC analysis previously described indicates a weight-average molecular weight of 32,470.
   Test No. 27

The following are introduced into a 1 liter glass reactor equipped with mechanical stirring and an oil bath type of heating system:
18.94 g methacrylic acid,
175 g water,
609.9 g of an aqueous solution containing 50% by weight of molecular weight 5000 polyethylene glycol methoxy methacrylate,
4.9 g butoxypoly(oxyethylene oxypropylene)methacrylate containing 10 oxyethylene motifs and 11 oxypropylene motifs.

The medium is heated to 95° C. and gradually, over a period of 2 hours, a solution is introduced consisting of 6.6 g of the following alkoxyamine, previously diluted in 75.0 g water and 1.81 g caustic soda at 50%:

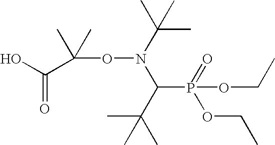

The mixture is then heated for 1 hour with stirring at 95° C.

The medium is neutralized to pH 8 with 50% caustic soda solution.

A clear aqueous solution is obtained containing 36.4% of dry matter of a polymer consisting by weight of:
7.5% methacrylic acid,
91.0% molecular weight 5000 polyethylene glycol methoxy methacrylate,
1.5% butoxypoly(oxyethylene oxypropylene)methacrylate containing 10 oxyethylene motifs and 11 oxypropylene motifs.
   of which the GPC analysis previously described indicates a weight-average molecular weight of 53,070.
   Test No. 28

The following are introduced into a 1 liter glass reactor equipped with mechanical stirring and an oil bath type of heating system:
20.66 g methacrylic acid
175 g water
609.9 g of an aqueous solution containing 50% by weight of molecular weight 5000 polyethylene glycol methoxy methacrylate,
4.9 g butoxypoly(oxyethylene oxypropylene)methacrylate containing 10 oxyethylene motifs and 11 oxypropylene motifs.

The medium is heated to 95° C. and gradually, over a period of 2 hours, a solution is introduced consisting of 6.6 g of the following alkoxyamine, previously diluted in 75.0 g water and 1.81 g caustic soda at 50%:

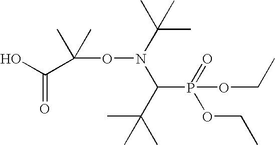

The mixture is then heated for 1 hour with stirring at 95° C.

The medium is neutralized to pH 8 with 50% caustic soda solution.

A clear aqueous solution is obtained containing 35.2% of dry matter of a polymer consisting by weight of:
7.5% methacrylic acid,
91.0% molecular weight 5000 polyethylene glycol methoxy methacrylate,
1.5% butoxypoly(oxyethylene oxypropylene)methacrylate containing 10 oxyethylene motifs and 11 oxypropylene motifs.
   of which the GPC analysis previously described indicates a weight-average molecular weight of 51,900.
   Test No. 29

The following are introduced into a 1 liter glass reactor equipped with mechanical stirring and an oil bath type of heating system:
20.66 g methacrylic acid
270 g water
572.8 g of an aqueous solution containing 50% by weight of molecular weight 2000 polyethylene glycol methoxy methacrylate,
5.9 g butoxypoly(oxyethylene oxypropylene)methacrylate containing 10 oxyethylene motifs and 11 oxypropylene motifs,
79.6 g tristyrylphenol methacrylate with 25 ethylene oxide motifs.

The medium is heated to 95° C. and gradually, over a period of 2 hours, a solution is introduced consisting of 15.87 g of the following alkoxyamine, previously diluted in 90.1 g water and 50.0 g caustic soda at 50%:

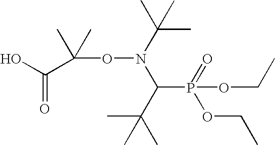

The mixture is then heated for 1 hour with stirring at 95° C.

The medium is neutralized to pH 8 with 50% caustic soda solution.

A clear aqueous solution is obtained containing 34.2% of dry matter of a polymer consisting by weight of:
18.5% methacrylic acid,
70.0% molecular weight 2000 polyethylene glycol methoxy methacrylate,
1.5% butoxypoly(oxyethylene oxypropylene)methacrylate containing 10 oxyethylene motifs and 11 oxypropylene motifs,
10% tristyrylphenol methacrylate with 25 ethylene oxide motifs,
   of which the GPC analysis previously described indicates a weight-average molecular weight of 52,700.
   Test No. 30

The following are introduced into a 1 liter glass reactor equipped with mechanical stirring and an oil bath type of heating system:
16.65 g methacrylic acid
270 g water
572.8 g of an aqueous solution containing 50% by weight of molecular weight 2000 polyethylene glycol methoxy methacrylate,
5.9 g butoxypoly(oxyethylene oxypropylene)methacrylate containing 10 oxyethylene motifs and 11 oxypropylene motifs,
79.6 g nonylphenol methacrylate with 50 ethylene oxide motifs.

The medium is heated to 95° C. and gradually, over a period of 2 hours, a solution is introduced consisting of 15.9 g of the following alkoxyamine, previously diluted in 90.0 g water and 4.05 g caustic soda at 50%:

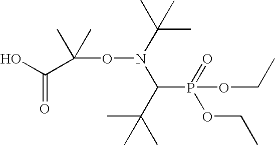

The mixture is then heated for 1 hour with stirring at 95° C.

The medium is neutralized to pH 8 with 50% caustic soda solution.

A clear aqueous solution is obtained containing 34.0% of dry matter of a polymer consisting by weight of:
18.5% methacrylic acid,
70.0% molecular weight 2000 polyethylene glycol methoxy methacrylate,
1.5% butoxypoly(oxyethylene oxypropylene)methacrylate containing 10 oxyethylene motifs and 11 oxypropylene motifs,
10% nonylphenol methacrylate with 50 ethylene oxide motifs,
   of which the GPC analysis previously described indicates a weight-average molecular weight of 52,700.
   Test No. 31

The following are introduced into a 1 liter glass reactor equipped with mechanical stirring and an oil bath type of heating system:
54.0 g methacrylic acid,
270 g water,
246.8 g of urethane methacrylate, produced by the reaction of ethylene glycol methacrylate and toluene diisocyanate and methoxy polyethylene glycol with weight-average molecular weight equal to 5000,
17.2 g ethyl methacrylate.

The medium is heated to 95° C. and gradually, over a period of 2 hours, a solution is introduced consisting of 5.57 g of the following alkoxyamine, previously diluted in 90.0 g water and 1.4 g caustic soda at 50%:

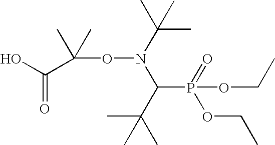

The mixture is then heated for 1 hour with stirring at 95° C.

The medium is neutralized to pH 8 with 50% caustic soda solution.

A clear aqueous solution is obtained containing 41.1% of dry matter of a polymer consisting by weight of:
17.0% methacrylic acid,
77.6% of urethane methacrylate, produced by the reaction of ethylene glycol methacrylate and toluene diisocyanate and methoxy polyethylene glycol with weight-average molecular weight 5000,
5.4% ethyl methacrylate,
   of which the GPC analysis previously described indicates a weight-average molecular weight of 105,730.
   Test No. 32

The following are introduced into a 1 liter glass reactor equipped with mechanical stirring and an oil bath type of heating system:
54.0 g methacrylic acid,
270 g water,
655 g of an aqueous solution containing 50% by weight of molecular weight 2000 polyethylene glycol methoxy methacrylate,
5.9 g butoxypoly(oxyethylene oxypropylene)methacrylate containing 10 oxyethylene motifs and 11 oxypropylene motifs.

The medium is heated to 95° C. and gradually, over a period of 2 hours, a solution is introduced consisting of 15.86 g of the following alkoxyamine, previously diluted in 90.0 g water and 4.0 g caustic soda at 50%:

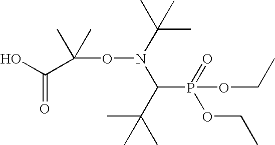

The mixture is then heated for 1 hour with stirring at 95° C.

The medium is neutralized to pH 8 with 50% caustic soda solution.

A clear aqueous solution is obtained containing 34.6% of dry matter of a polymer consisting by weight of:
18.5% methacrylic acid,
80.0% molecular weight 2000 polyethylene glycol methoxy methacrylate,
1.5% butoxypoly(oxyethylene oxypropylene)methacrylate containing 10 oxyethylene motifs and 11 oxypropylene motifs,
   of which the GPC analysis previously described indicates a weight-average molecular weight of 27,630.
   Test No. 33

The following are introduced into a 1 litre glass reactor equipped with mechanical stirring and a heating system of the oil bath type:
11.9 g of methacrylic acid,
270 g of water,
736.4 g of a 50% weight concentration aqueous solution of methoxy polyethylene glycol methacrylate with a molecular weight of 2000,
5.9 g of butoxypoly(oxyethylene oxypropylene)methacrylate comprising 10 oxyethylene units and 11 oxypropylene units.

The medium is heated to 95° C. and, little by little, over a period of 2 hours, a solution is introduced consisting of 15.86 g of the following alcoxyamine, previously diluted in 90.0 g of water and 4.28 g of 50% sodium hydroxide:

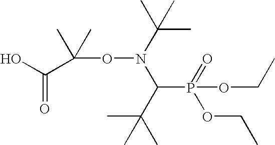

Heat for 1 hour with stirring at 95° C.

The medium is neutralised to pH 8 with a 50% solution of caustic soda.

A clear aqueous solution is obtained containing 33.7% of dry matter of a polymer, in weight consisting of:
8.5% methacrylic acid,
90.0% methoxy polyethylene glycol methacrylate with a molecular weight of 2000,
1.5% butoxypoly(oxyethylene oxypropylene)methacrylate comprising 10 oxyethylene units and 11 oxypropylene units,
   whose GPC analysis, as described above, indicates a weight-average molecular weight Mw of 25,830.
   Test No. 34

The following are introduced into a 1 litre glass reaction vessel equipped with mechanical stirring and a heating system of the oil bath type:
96.35 g of methacrylic acid,
270 g of water,
572.8 g of a 50% weight concentration aqueous solution of methoxy polyethylene glycol methacrylate with a molecular weight of 2000,
5.9 g of butoxypoly(oxyethylene oxypropylene)methacrylate comprising 10 oxyethylene units and 11 oxypropylene units.

The medium is heated to 95° C. and, little by little, over a period of 2 hours, a solution is introduced consisting of 15.86 g of the following alcoxyamine, that was diluted in 90.0 g of water and 4.08 g of 50% sodium hydroxide:

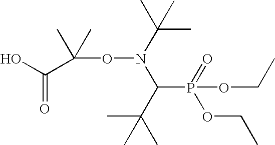

Heat for 1 hour with stirring at 95° C.

The medium is neutralised to pH 8 with a 50% solution of caustic soda.

A clear aqueous solution is obtained with 35.4% dry matter of a polymer in weight consisting of:
28.5% methacrylic acid,
70.0% methoxy polyethylene glycol methacrylate of molecular weight of 2000,
1.5% of butoxypoly(oxyethylene oxypropylene)methacrylate comprising 10 oxyethylene units and 11 oxypropylene units,
   whose GPC analysis, as described above, indicates a mean weight-average molecular weight Mw of 24,950.
   Test No. 35

The following are introduced into a 1 litre glass reaction vessel equipped with mechanical stirring and a heating system of the oil bath type:
316.7 g of methacrylic acid,
216 g of water,
4.72 g of butoxypoly(oxyethylene oxypropylene)methacrylate comprising 10 oxyethylene units and 11 oxypropylene units.

The medium is heated to 95° C. and, little by little, over a period of 2 hours, a solution is introduced consisting of 12.69 g of the following alcoxyamine, that was diluted in 72.0 g of water and 3.3 g of 50% sodium hydroxide:

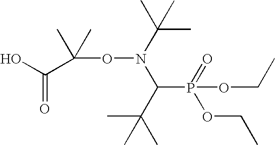

Heat for 1 hour with stirring at 95° C.

The medium is neutralised to pH 8 with a 50% solution of caustic soda.

A clear aqueous solution is obtained with 33.3% dry matter of a polymer in weight consisting of:
98.5% methacrylic acid,
1.5% of butoxypoly(oxyethylene oxypropylene)methacrylate comprising 10 oxyethylene units and 11 oxypropylene units,
   whose GPC analysis, as described above, indicates a weight-average molecular weight Mw of 22,400.
   Test No. 36

The following are introduced into a 1 litre glass reaction vessel equipped with mechanical stirring and a heating system of the oil bath type:
163.0 g of methacrylic acid,
198.5 g of methoxy polyethylene glycol methacrylate with a molecular weight of 2000,
270 g of water,
5.9 g of butoxypoly(oxyethylene oxypropylene)methacrylate comprising 10 oxyethylene units and 11 oxypropylene units.
The medium is heated to 95° C. and, little by little, over a period of 2 hours, a solution is introduced consisting of 15.86 g of the following alcoxyamine, that was diluted in 90.0 g of water and 4.05 g of 50% sodium hydroxide:

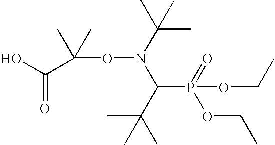

Heat for 1 hour with stirring at 95° C.

The medium is neutralised to pH 8 with a 50% solution of caustic soda.

A clear aqueous solution is obtained with 38.1% dry matter of a polymer in weight consisting of:
49.0% methacrylic acid,
49.5% methoxy polyethylene glycol methacrylate of molecular weight of 2000,
1.5% of butoxypoly(oxyethylene oxypropylene)methacrylate comprising 10 oxyethylene units and 11 oxypropylene units,
   whose GPC analysis, as described above, indicates a weight-average molecular weight Mw of 25,430.
   Test No. 37

The following are introduced into a 1 litre glass reaction vessel equipped with mechanical stirring and a heating system of the oil bath type:
358.2 g of methacrylic acid,
39.8 g of methacrylate phosphate of ethylene glycol,
270 g of water.

The medium is heated to 95° C. and, little by little, over a period of 2 hours, a solution is introduced consisting of 16.0 g of the following alcoxyamine, that was diluted in 90.0 g of water and 4.0 g of 50% sodium hydroxide:

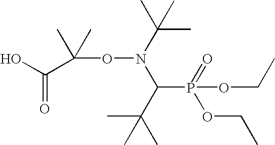

Heat for 1 hour with stirring at 95° C.

The medium is neutralised to pH 8 with a 50% solution of caustic soda.

A clear aqueous solution is obtained with 34.6% dry matter of a polymer in weight consisting of:
90.0% methacrylic acid,
10.0% methacrylate phosphate of ethylene glycol,
   whose GPC analysis, as described above, indicates a weight-average molecular weight Mw of 25,400.
   Test No. 38

The following are introduced into a 1 litre glass reaction vessel equipped with mechanical stirring and a heating system of the oil bath type:
318.4 g of methacrylic acid,
79.6 g of acrylamide,
270 g of water,

The medium is heated to 95° C. and, little by little, over a period of 2 hours, a solution is introduced consisting of 16.0 g of the following alcoxyamine, that was diluted in 90.0 g of water and 4.0 g of 50% sodium hydroxide:

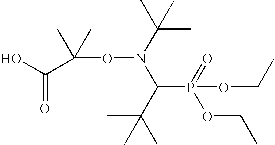

Heat for 1 hour with stirring at 95° C.

The medium is neutralised to pH 8 with a 50% solution of caustic soda.

A clear aqueous solution is obtained with 39.1% dry matter of a polymer in weight consisting of:
80.0% methacrylic acid,
20.0% acrylamide,
   whose GPC analysis, as described above, indicates a weight-average molecular weight Mw of 25,200.
   Test No. 39

The following are introduced into a 1 litre glass reaction vessel equipped with mechanical stirring and a heating system of the oil bath type:
318.4 g of methacrylic acid,
79.6 g of itaconic acid,
250 of water.

The medium is heated to 95° C. and, little by little, over a period of 2 hours, a solution is introduced consisting of 16.0 g of the following alcoxyamine, that was diluted in 90.0 g of water and 4.0 g of 50% sodium hydroxide:

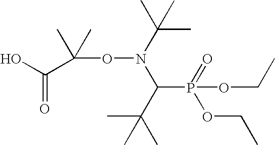

Heat for 1 hour with stirring at 95° C.

The medium is neutralised to pH 8 with a 50% solution of caustic soda.

A clear aqueous solution is obtained with 37.3% dry matter of a polymer in weight consisting of:
80.0% methacrylic acid,
20.0% itaconic acid,
   whose GPC analysis, as described above, indicates a weight-average molecular weight Mw of 26,000.
   Test No. 40

The following are introduced into a 1 litre glass reaction vessel equipped with mechanical stirring and a heating system of the oil bath type:
318.4 g of methacrylic acid,
79.6 g of acrylamidomethylpropanesulfonic acid,
250 g of water.

The medium is heated to 95° C. and, little by little, over a period of 2 hours, a solution is introduced consisting of 16.0 g of the following alcoxyamine, that was diluted in 90.0 g of water and 4.0 g of 50% sodium hydroxide:

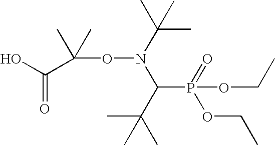

Heat for 1 hour with stirring at 95° C.

The medium is neutralised to pH 8 with a 50% solution of caustic soda.

A clear aqueous solution is obtained with 37.3% dry matter of a polymer in weight consisting of:
80.0% methacrylic acid,
20.0% acrylamidomethylpropanesulfonic acid,
   whose GPC analysis, as described above, indicates a weight-average molecular weight Mw of 26,000.
   Test No. 41

The following are introduced into a 1 litre glass reaction vessel equipped with mechanical stirring and a heating system of the oil bath type:
318.5 g of methacryloyloxyethyltrimethylammonium chloride.

The medium is heated to 95° C. and, little by little, over a period of 2 hours, a solution is introduced consisting of 12.7 g of the following alcoxyamine, that was diluted in 72.0 g of water and 3.4 g of 50% sodium hydroxide:

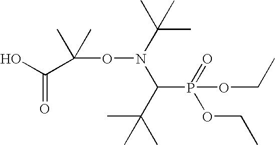

Heat for 1 hour with stirring at 95° C.

The medium is neutralised to pH 8 with a 50% solution of caustic soda.

A clear aqueous solution is obtained with 37.3% dry matter of a homopolymer of methacryloyloxyethyltrimethylammonium chloride, whose GPC analysis, as described above, indicates a weight-average molecular weight Mw of 26,000.

### EXAMPLE 6

This example concerns the use of grinding aid agents according to the invention for the grinding of a calcium carbonate that is chalk, the aqueous suspensions according to the invention thereby obtained, their use according to the invention in the manufacture of ceramic compositions, and finally the ceramic compositions obtained according to the invention.

First, begin by crushing the mineral filler, according to the following procedure. In a planet mixer whose speed of rotation is at least equal to 20 000 r.p.m., transfer 300 grams of aluminium oxide balls as grinding substance, 200 grams of calcium carbonate which is the chalk, 117 grams of water and 1.6 grams of test polymer. This calcium carbonate has initially been passed through a screen whose mesh is equal to 45 μm. Thereby, determine the percentage in weight of particles exceeding 45 μm. This value equals 95%.

The mixture is crushed for 10 minutes at 20 000 r.p.m.

For each test polymer, two identical suspensions are made according to the previously described method.

The first suspension is rinsed, dried and then passed through the same screen as used above.

The other suspension will be used to formulate the ceramic compositions.

Test No. 42

This test illustrates the invention and uses the polymer described in test No. 26. Two aqueous suspensions of chalk are made according to the previously described method. In the first, once rinsed and dried, the percentage in weight of the particles exceeding 45 μm is 5.21%.

Test No. 43

This test illustrates the invention and uses the polymer described in test No. 26. In the first, once rinsed and dried, the percentage in weight of particles exceeding 45 μm is 5.21%.

These results show that the polymers can be used according to the invention as grinding aid agents for chalk.

Secondly, ceramic compositions are made from aqueous suspensions of the ground mineral matter, that has not been rinsed and dried, obtained during tests No. 42 and No. 43.

To accomplish this, take a plastic 500 millilitre beaker equipped with a stirring blade (diameter: 60 mm) and add 162 grams of untreated water and, after beginning stirring at a speed of 1300 r.p.m., add the suspension of the mineral matter to be tested.

After 20 minutes of stirring at 1300 r.p.m., measure the viscosity of the suspension obtained by determination of the RVT type Brookfield™ viscosity at 10 r.p.m. according to the method previously described in the present application.

Test No. 44

This test illustrates the invention and uses the aqueous suspension, that has not been rinsed and dried, described in test No. 42.

The RVT type Brookfield™ viscosity at 10 r.p.m. measured for the suspension obtained then equals 21,200 mPa·s.

Test No. 45

This test illustrates the invention and uses the aqueous suspension, that has not been rinsed and dried, described in test No. 43.

The RVT type Brookfield™ viscosity at 10 r.p.m. measured for the suspension obtained then equals 7,900 mPa·s.

The viscosity values obtained during tests No. 44 and No. 45 demonstrate that the use of aqueous suspensions of mineral matter according to the invention, obtained by the use of grinding aid agents according to the invention, is possible in the domain of ceramics.

### EXAMPLE 7

This example illustrates the direct use of dispersing agents according to the invention in a drilling mud, and the drilling mud according to the invention thereby obtained.

For tests No. 46 and No. 47, drilling muds are made according to the following procedure, where the composition of the aforementioned drilling muds is provided in Table 3.

Prepare the drilling mud by transferring the following to a Hamilton Beach™ bowl commercialised by Hamilton Beach:
375.9 g of synthetic sea water (deionised water containing 44.05 g/l of NaCl, 0.67 g/l of KCl, 1.36 g/l of CaCl₂, 2H₂O, 4.66 g/l of MgCl₂, 6H₂O, 6.29 g/l of MgSO₄, 7H₂O, 0.18 g/l of NaHCO₃),
17.655 g (or 48.77 g/l) of Zéogel™, a clay commercialised by BAROIDυ while maintaining the stirring in “low” position for 10 minutes,
10.088 g of Aquagel™, a clay commercialised by BAROID™ while maintaining the stirring in “low” position for 10 minutes,
277.5 g of barium sulphate, while maintaining the stirring for 15 minutes,
5.35 g of Thermacheck™, a filtrate reducer commercialised by BAROID™, while maintaining the stirring for 15 minutes,
   the pH is then adjusted to 10.5 with sodium hydroxide.

686.5 g of drilling mud is then transferred to the bowl and 5.0 grams of the test polymer is then possibly added. The pH is maintained at 10.5 by the addition of sodium hydroxide.

A Fann™ viscosimeter commercialised by Fann is then used to measure the viscosity.

The viscosities are measured at 600, 200, 100, 6, and 3 r.p.m.

Then calculate:
The apparent viscosity (Va)

$$Va ( m Pa . s ) = \frac{Reading at 600 r . p . m .}{2}$$
The plastic viscosity (Vp):
   Vp(mPa·s)=reading at 600 r.p.m.−reading at 300 r.p.m.
The yield value:
   Yv=2×(Va−Vp)

The corresponding results are provided in Table 3.

Test No. 46

This test illustrates the prior art and uses the previously described drilling mud, without the addition of a polymer.

Test No. 47

This test illustrates the invention and, according to the invention, uses the polymer described in test No. 26.

TABLE 3

| | | Test No. 46 | | Test No. 47 | |
|---|---|---|---|---|---|
| Composition | Sea water | 375.9 | ml | 375.9 | ml |
| | Zéogel ™ | 17.655 | g | 17.655 | g |
| | Aquagel ™ | 10.088 | g | 10.088 | g |
| | Barium sulphate | 277.5 | g | 277.5 | g |
| | Therma Check ™ | 5.35 | g | 5.35 | g |
| | Polymer according to test | 0 | g | 5.00 | g |
| | No. 26 | | | | |
| Rheology | Reading at 300 r.p.m. | 114 | | 81 | |
| | Reading at 200 r.p.m. | 97 | | 73 | |
| | Reading at 6 r.p.m. | 48 | | 45 | |
| | Reading at 3 r.p.m. | 46 | | 44 | |
| | Vp | 40 | | 25 | |
| | Yv | 74 | | 56 | |

The apparent viscosity and yield value in Table 3 demonstrate that the use of dispersing agents according to the invention is possible in drilling muds.

### EXAMPLE 8

This example illustrates the direct use of dispersing agents according to the invention in detergent formulations for scouring creams, and the aforementioned creams obtained according to the invention.

For tests No. 48 to No. 51, prepare scouring creams by transfering the following into a planet grinder with a speed of rotation of at least 20,000 r.p.m.: a mineral filler that is calcium carbonate commercialised by OMYA™ under the name of Omyacarb™ 30 AV, water, a surfactant that is Ethylan™ 1005 commercialised by AKZO NOBEL™, and the dipersing agent according to the invention. The corresponding quantities are provided in Table 4.

Then add sodium hydroxide so as to obtain a pH equal to 8.

These products are mixed for 5 minutes in the planet grinder at 20 000 r.p.m. Then determine the RVT type Brookfield™ viscosity at 20 r.p.m. according to the method previously described in the present application.

Test No. 48

This test illustrates the invention and uses the polymer according to test No. 24.

Test No. 49

This test illustrates the invention and uses the polymer according to test No. 25.

Test No. 50

This test illustrates the invention and uses the polymer according to test No. 28.

Test No. 51

This test illustrates the invention and uses the polymer according to test No. 29.

The compositions of the scouring formulations and the RVT type Brookfield™ viscosities at 20 r.p.m. obtained for tests No. 41 to No. 44 are provided in Table 4.

TABLE 4

| | | Test | Test | Test | Test |
|---|---|---|---|---|---|
| | | No. | No. | No. | No. |
| | | 48 | 49 | 50 | 51 |
| Composition | Omyacarb ™ | 80 | 80 | 52 | 52 |
| (quantities | 30 AV | | | | |
| in g) | water | 111 | 111 | 139 | 139 |
| | Ethylan ™ | 6 | 2 | 6 | 2 |
| | 1005 | | | | |
| | Dispersing | 1.38 | 1.85 | 2.83 | 2.89 |
| | agent | | | | |
| | according to | | | | |
| | the invention | | | | |

| | | | | |
|---|---|---|---|---|
| RVT type Brookfield ™ | 2075 | 2250 | 2400 | 3050 |
| viscosity at 20 r.p.m. | | | | |

The RVT type Brookfield™ viscosities at 20 r.p.m. demonstrate that the dispersing agents according to the invention may be directly used in scouring creams in detergency.

### EXAMPLE 9

This example illustrates the use of aqueous suspensions of mineral matter ground according to the invention, in detergent formulations of scouring creams, and the aforementioned creams obtained according to the invention.

For tests No. 52 to No. 55, scouring creams are prepared by introducing into a planet grinder with a speed of rotation at least equal to 20 000 r.p.m.: an aqueous suspension of mineral matter according to the invention that was obtained by grinding calcium carbonate with a dispersing agent according to the invention, water, a surfactant which is Ethylan™ 1005 commercialised by AKZO NOBEL™, and the test dispersing agent. Then add sodium hydroxide so as to obtain a pH equal to 8.

These products are mixed for 5 minutes in a planet grinder at a speed of 20 000 r.p.m. For the compositions obtained, then determine the RVT type Brookfield™ viscosity at 20 r.p.m. according to the method previously described in the present application.

Test No. 52

This test illustrates the invention and uses the aqueous suspension of ground calcium carbonate according to test No. 5.

Test No. 53

This test illustrates the invention and uses the aqueous suspension of ground calcium carbonate according to test No. 6.

Test No. 54

This test illustrates the invention and uses the aqueous suspension of ground calcium carbonate according to test No. 7.

Test No. 55

This test illustrates the invention and uses the aqueous suspension of ground calcium carbonate according to test No. 8.

The composition of the scouring formulations and the RVT type Brookfield™ viscosities at 20 r.p.m. obtained for tests No. 52 to No. 55 are indicated in Table 5.

TABLE 5

| | | Test | Test | Test | Test |
|---|---|---|---|---|---|
| | | No. | No. | No. | No. |
| | | 52 | 53 | 54 | 55 |
| Composition | Aqueous | 80 | 80 | 52 | 52 |
| (quantities | suspension | | | | |
| en g) | according | | | | |
| | to the | | | | |
| | invention | | | | |
| | Water | 111 | 111 | 139 | 139 |
| | Ethylan ™ | 6 | 2 | 6 | 2 |
| | 1005 | | | | |

| | | | | |
|---|---|---|---|---|
| RVT type Brookfield ™ | 2125 | 2350 | 2500 | 2850 |
| viscosity at 20 r.p.m. | | | | |

The RVT type Brookfield™ viscosities at 20 r.p.m. demonstrate that the aqueous suspensions of calcium carbonate ground according to the invention, may be used in scouring creams in detergency.

### EXAMPLE 10

This example illustrates the use of dispersing agents according to the invention, to disperse mineral matter in water, together with the aqueous dispersions of mineral matter obtained according to the invention.

To accomplish this, 321 grams of water, 0.2 grams of an anti-foaming agent commercialised by the company BYK™ under the name Byk™ 034, 1000 grams of titanium dioxide commercialised by the company TIOXIDE™ under the name RHD2, and a given quantity of the product for testing are introduced into a 1 litre beaker.

The mixture is subjected to constant agitation by means of a notched turbine of diameter 70 mm, at a speed of 1000 r.p.m., for 20 minutes.

A first measurement of Brookfield™ viscosity is then made, at 10 r.p.m.

Subsequently, successive additions of the product for testing are made, whilst agitating for 5 minutes at a speed of 1000 r.p.m. and then taking a new measurement of Brookfield™ viscosity at 10 r.p.m. (using the method and with the device previously described in the present document).

For tests No. 56 to No. 59 which use dispersing agents according to the invention, the Brookfield™ viscosity values (in mPa·s) obtained are listed in table 6, as a function of the percentage by dry weight of dispersing agent tested relative to the dry weight of the mineral matter.

Test No. 56

This test illustrates the invention and uses the dispersing agent according to the invention, as described in test No. 26.

Test No. 57

This test illustrates the invention and uses the dispersing agent according to the invention, as described in test No. 21.

Test No. 58

This test illustrates the invention and uses the dispersing agent according to the invention, as described in test No. 34.

Test No. 59

This test illustrates the invention and uses the dispersing agent according to the invention, as described in test No. 33.

TABLE 6

| Quantity of | | | | |
|---|---|---|---|---|
| tested product | Test No. 56 | Test No. 57 | Test No. 58 | Test No. 59 |
| 0.15% | | | 30000 | 30000 |
| 0.20% | 10000 | | 3210 | 5640 |
| 0.25% | 3910 | 2010 | 980 | 1620 |
| 0.30% | 1320 | 750 | 590 | 880 |
| 0.35% | 660 | 560 | 390 | |
| 0.37% | | | | 470 |
| 0.40% | 420 | 530 | 300 | 370 |
| 0.45% | 300 | 520 | 270 | 320 |
| 0.50% | 290 | 510 | 260 | 240 |
| 0.55% | 220 | 550 | 260 | 210 |
| 0.60% | 170 | 620 | | 180 |
| 0.65% | 140 | | | 180 |
| 0.70% | 130 | 450 | 300 | 190 |

A reading of the Brookfield™ viscosity values at 20 r.p.m. shows that the dispersing agents according to the invention may be used to disperse titanium dioxide in water.

### EXAMPLE 11

This example illustrates the direct use of dispersing agents according to the invention in aqueous paint formulations, and the aqueous paint formulations according to the invention thus obtained.

To accomplish this, an aqueous paint formulation is produced using methods well known to the skilled man in the art, adding to it 0.24% by dry weight of a dispersing agent according to the invention, relative to the total weight of the formulation: the compositions of these formulations are indicated in table 7.

For each of the paints thus formulated, its Brookfield™ viscosity is determined at 10 r.p.m. using the procedure described above.

Its ICI™ and Stormer™ viscosities are also determined using the following methods. The ICI™ viscosity is determined in a cone-plane viscometer, known as an ICI™ viscometer, commercialised by the company ERICHSEN™, using the method well known to the skilled man in the art. The measurement is made at 25° C.

The Stormer™ viscosity is determined in a Stormer viscometer of type KU-1 commercialised by the company Brookfield™, fitted with a unique measuring system. The measurement is made at 25° C.

The same measurements were made after a period of 24 hours of storage of the paints at ambient temperature.

Test No. 60

This test illustrates the invention and uses the polymer according to test No. 26.

Test No. 61

This test illustrates the invention and uses the polymer according to test No. 21.

The results for the Brookfield™, ICI™ and Stormer™ viscosities, measured for tests No. 60 and No. 61, are shown in table 7.

TABLE 7

| | | | Test No. | Test No. |
|---|---|---|---|---|
| | | | 60 | 61 |
| Constituents | | Propylene glycol | 40.0 | 40.0 |
| (quantities | | Water | 112.7 | 112.7 |
| in grams) | | Coatex ™ BR3 | 0 | 0 |
| | | Dispersing agent | 7.8 | 7.3 |
| | | according to the | | |
| | | invention | | |
| | | Mergal ™ K6N | 2.0 | 2.0 |
| | | Nopco ™ NDW | 2.0 | 2.0 |
| | | RHD2 | 200.0 | 200.0 |
| | | Hydrocarb ™ | 150.0 | 150.0 |
| | | Rhodopas ™ DS 910 | 450.0 | 450.0 |
| | | Butyldiglycol | 30.0 | 30.0 |
| | | Coatex ™ BR 100P | 3.0 | 3.0 |
| | | Ammonia (31%) | 3.0 | 3.0 |
| Viscosities | T = 0 | ICI ™ viscosity (P) | 1.4 | 1.5 |
| | | Stormer ™ viscosity | 92 | 108 |
| | | (K · U) | | |
| | | Brookfield ™ | 4 500 | 5 800 |
| | | viscosities | | |
| | | (mPa · s) | | |
| | | at 10 r.p.m. | | |
| | T = 24 | ICI ™ viscosity (P) | 1.3 | 1.5 |
| | hours | Stormer ™ | 140 | >141 |
| | | viscosity (K · U) | | |
| | | Brookfield ™ | 17 400 | 24 400 |
| | | viscosities | | |
| | | (mPa · s) | | |
| | | at 10 r.p.m. | | |

Coatex ™ BR 100 is a thickener commercialised by the company COATEX ™.
Mergal ™ K6N is a bactericide commercialised by the company TROY ™.
Nopco ™ NDW is an anti-foaming agent commercialised by the company COGNIS ™.
Rhodopas ™ 290 D is a styrene acrylic binder commercialised by the company RHODIA ™.

The values of the different viscosities obtained in table 7 show that direct use of dispersing agents according to the invention is possible in the field of aqueous paints.

### EXAMPLE 12

This example illustrates the use of aqueous dispersions of mineral matter obtained with dispersing agents according to the invention, in aqueous paint formulations, and the aqueous paint formulations according to the invention thus obtained.

To accomplish this, an aqueous paint formulation is produced using methods well known to the skilled man in the art, introducing into it, notably 200 grams of aqueous dispersion of titanium dioxide according to tests No. 56 and No. 57, accomplished with 0.70% by dry weight of dispersing agent according to the invention relative to the dry weight of mineral matter. The corresponding formulations are shown in table 8.

Test No. 62

This test illustrates the invention and uses the aqueous suspensions according to the invention described in test No. 56.

Test No. 63

This test illustrates the invention and uses the aqueous suspensions according to the invention described in test No. 57.

As for example 11, the ICI™, Stormer™ and Brookfield™ viscosities of the aqueous paints thus manufactured are obtained, immediately after formulation, and subsequently after a storage time of 24 hours at ambient temperature.

The corresponding results are shown in table 8.

TABLE 8

| | | | Test No. | Test No. |
|---|---|---|---|---|
| | | | 62 | 63 |
| Constituents | | Propylene glycol | 40.0 | 40.0 |
| (quantities | | Water | 56.3 | 55.8 |
| in grams) | | Coatex ™ BR3 | 0 | 0 |
| | | Mergal ™ K6N | 2.0 | 2.0 |
| | | Nopco ™ NDW | 2.0 | 2.0 |
| | | Aqueous dispersion | 264.2 | 0.0 |
| | | according to | | |
| | | test No. 56* | | |
| | | Aqueous dispersion | 0.0 | 264.2 |
| | | according to | | |
| | | test No. 57* | | |
| | | Hydrocarb ™ | 150.0 | 150.0 |
| | | Rhodopas ™ DS 910 | 450.0 | 450.0 |
| | | Butyldiglycol | 30.0 | 30.0 |
| | | Coatex ™ BR 100P | 3.0 | 3.0 |
| | | Ammonia (31%) | 3.0 | 3.0 |
| Viscosities | T = 0 | ICI ™ viscosity (P) | 1.5 | 1.6 |
| | | Stormer ™ | 93 | 110 |
| | | viscosity (K · U) | | |
| | | Brookfield ™ | 4 600 | 5 900 |
| | | viscosity | | |
| | | (mPa · s) | | |
| | | at 10 r.p.m. | | |
| | T = 24 | ICI ™ viscosity (P) | 1.4 | 1.6 |
| | hours | Stormer ™ | 140 | >141 |
| | | viscosity (K · U) | | |
| | | Brookfield ™ | 19 000 | 26 000 |
| | | viscosity | | |
| | | (mPa · s) | | |
| | | at 10 r.p.m. | | |

*the said aqueous suspensions contain 0.70% by dry weight of dispersing agent according to the invention relative to the dry weight of mineral matter.
Coatex ™ BR 100 is a thickener commercialised by the company COATEX ™.
Mergal ™ K6N is a bactericide commercialised by the company TROY ™.
Nopco ™ NDW is an anti-foaming agent commercialised by the company COGNIS ™.
Rhodopas ™ 290 D is a styrene acrylic binder commercialised by the company RHODIA ™.

The values of the different viscosities obtained in table 8 show that the use of aqueous suspensions according to the invention of mineral matter dispersed with dispersing agents according to the invention is possible in the aqueous paints field.

### EXAMPLE 13

This example illustrates the use of aqueous dispersions of mineral matter according to the invention accomplished with dispersing agents according to the invention, in the formulation of mortars used in the cement industry, together with the said mortars obtained according to the invention.

With this aim, for each of the tests in the example, the various constituents of the standard mortar dosed with 450 kg/m³ of cement are poured into a mortar mixer (EN 196-1) under operation. The composition of the cement is as follows:
450 g of cement CEM I 42.5R CP2 from Gaurain in compliance with norm NF P 15-301;
the quantity of calcium carbonate dispersion to be tested;
the quantity of water required;
a variable quantity in grams of standardised sand from Leucate (EN 196-1). This quantity of sand is added for 30 seconds and after 30 seconds of rapid agitation of the mixture of the constituents previously added.

The quantities of the constituents are adjusted for each of the mortars of the various tests in order to work with constant compactness.

After 90 seconds' mixing it is stopped in order to be able to scrape the walls of the mixer.

When the scraping of the mortar adhering to the walls is finished the mixing is continued for 1 minute at rapid speed.

By adhering to these times we were able to obtain a mixing cycle lasting 4 minutes and in compliance with norm EN 196-1.

The workability of the mortars thus formulated is determined on a mortar workability meter as defined by norm NF P 15-412.

Test No. 64

This test illustrates the invention and is relative to a mortar according to the invention, dosed with 450 kg/m³ with a water/cement ratio of 0.46 and using 10% by dry weight, relative to the dry weight of the cement, of an aqueous dispersion of a calcite at 20% by dry weight of median diameter 2 micrometers measured using a Sedigraph™ 5100, using 0.70%, by dry weight relative to the dry weight of calcium carbonate, of the copolymer of test No. 38.

With this aim, and using an electromagnetic agitator with blades, the aqueous dispersion of calcium carbonate is prepared by introducing the mineral filler into the water to which the dispersant copolymer has been added.

Test No. 65

This test illustrates the invention and is relative to a mortar according to the invention, dosed with 450 kg/m³ with a water/cement ratio of 0.41 and using 30% by dry weight, relative to the dry weight of the cement, of a dispersion of calcite at 45% of dry weight of median diameter of 2 micrometers measured using a Sedigraph™ 5100, using 0.70%, by dry weight, relative to the dry weight of calcium carbonate, of the copolymer of test No. 38.

The operating method and the equipment used for the calcium carbonate dispersion are identical to those of test No. 64.

The workability measurement results are shown in table 9.

TABLE 9

| | Test | Test |
|---|---|---|
| Compositions | No. 64 | No. 65 |
| Weight of cement, g | 450 | 450 |
| Weight of sand, g | 1533 | 1539 |
| Weight of calcium carbonate, g | 45 | 155 |
| Effective water/Cement ratio | 0.46 | 0.41 |
| Workability, seconds | 2.80 | 2.55 |

The results of table 9 show that aqueous dispersions of mineral matter according to the invention and accomplished with dispersing agents according to the invention may be used for producing mortars.

### EXAMPLE 14

This example illustrates the use of dispersing agents according to the invention to disperse a mineral matter, which is kaolin, in water.

To accomplish this, 500 grams of a mineral filler, which is kaolin commercialised by the company CADAM™ under the name Amazon+™, 175 grams of water, and 1 gram of sodium hydroxide at 12.5% are introduced in a beaker of 1000 millilitres.

Using a Rayneri™ Turbotest device, this mixture is put under agitation at a speed of 2000 r.p.m.

Successive additions of dispersing agent according to the invention are made, whilst agitating the mixture for 2 minutes at a speed of 2000 r.p.m.; a Brookfield™ viscosity measurement is then undertaken at 100 r.p.m. using the method described above.

Test No. 66

This test illustrates the invention and uses the polymer according to test No. 23.

Test No. 67

This test illustrates the invention and uses the polymer according to test No. 25.

Test No. 68

This test illustrates the invention and uses the polymer according to test No. 28.

Test No. 69

This test illustrates the invention and uses the polymer according to test No. 32.

Test No. 70

This test illustrates the invention and uses the polymer according to test No. 34.

The corresponding results are shown in table 10, which indicates firstly the quantity of the tested product expressed as a percentage by dry weight of dispersing agent according to the invention relative to the dry weight of mineral matter, and also the values of the Brookfield™ viscosity measured at 100 r.p.m. and expressed as mPa·s.

TABLE 10

| Quantity of | Test | Test | Test | Test | Test No. |
|---|---|---|---|---|---|
| product tested | No. 66 | No. 67 | No. 68 | No. 69 | 70 |
| 0.12 | 27 040 | 11 760 | | 6 890 | 5 150 |
| 0.138 | 16 160 | | | 4 220 | 3 290 |
| 0.15 | | 4 930 | | 3 540 | |
| 0.17 | 10 960 | 4 820 | | | 2 590 |
| 0.177 | | | | 2 510 | |
| 0.19 | | 3 030 | | | |
| 0.22 | | | | 1 830 | |
| 0.25 | | | | | 1 800 |
| 0.28 | | | 4 510 | | |
| 0.32 | 3 440 | | 2 440 | | |
| 0.34 | | | 2 310 | | |
| 0.45 | | | | | 1 230 |

The results in table 10 show that the dispersing agents according to the invention may be used to disperse kaolin in water. In addition, the skilled man in the art observe on reading the Brookfield™ viscosities measured at 100 r.p.m. that the said dispersions may be used in the paper production field, and notably in formulating paper coating.

### EXAMPLE 15

This example illustrates the use of grinding aid agents according to the invention to grind suspensions of calcium carbonate, suspensions according to the invention thus obtained, their use according to the invention in the formulation of paper coating slips, and the paper coating slips according to the invention thus manufactured.

Initially a natural calcium carbonate, manufactured by the company OMYA™ under the name Omyacarb™ 10 AV, is ground.

The grinding procedure is identical to that described in example 2.

Test No. 71

This test illustrates the invention and uses 1.0% by dry weight of grinding agent according to the invention and as described in test No. 24, relative to the dry weight of calcium carbonate.

Test No. 72

This test illustrates the invention and uses 1.0% by dry weight of grinding agent according to the invention and as described in test No. 25, relative to the dry weight of calcium carbonate.

As with example 1, for aqueous suspensions of ground calcium carbonate their granulometry is determined, as are the RVT type Brookfield™ viscosities, measured at a temperature of 20° C. and at rotational speeds of 10 r.p.m. and 100 r.p.m., at t=0 and t=8 days after agitation (the measuring methods and the notations are identical to those used in example 1).

The corresponding measurements are shown in table 11.

TABLE 11

| | | | | Brookfield ™ | |
|---|---|---|---|---|---|
| | | Brookfield ™ | | viscosity (mPa · s) | |
| | | viscosity (mPa · s) | | at t = 8 d after | |
| Tests | Granulometry | à t = 0 | | agitation | |
| No. | % < 1 μm | μ₁₀ | μ₁₀₀ | μ₁₀ | μ₁₀₀ |
| 71 | 68.1 | 3 270 | 628 | 2 980 | 655 |
| 72 | 76.2 | 590 | 380 | 730 | 430 |

A reading of the results of table 11 shows that it is possible to use grinding agents according to the invention to grind mineral matter in aqueous suspension, and in particular natural calcium carbonate, and that it is possible to obtain aqueous suspensions of natural calcium carbonate containing the grinding agent according to the invention.

In a second stage, using methods well known to the skilled man in the art, paper coating, using 100 grams of aqueous suspensions of ground calcium carbonate, obtained in tests No. 71 and No. 72, were produced.

They contain in addition 11 grams of a binder commercialised by the company DOW™ under the name DL966, 0.4 grams of 2 co-binders, namely Mowiol 6/98 and Finnfix 10, commercialised respectively by the companies CLARIANT™ and METSA SERLA™, and 0.6 grams of an optical whitener, namely Blancophor™ P, commercialised by the company CLARLANT™.

Test No. 73

This test illustrates the invention and uses 100 grams of the aqueous suspension according to the invention and as described in test No. 71.

A paper coating is then obtained, the percentage by weight of mineral matter of which is 66.7%, and the pH of which is 8.4.

Test No. 74

This test illustrates the invention and uses 100 grams of the aqueous suspension according to the invention and as described in test No. 72.

A paper coating is then obtained, the percentage by weight of mineral matter of which is 67.0%, and the pH of which is 8.4.

Using the methods described above, the RVT type Brookfield™ viscosities at 10 and 100 r.p.m., for each of the coating slips obtained, were measured; the results are shown in table 12.

TABLE 12

| Tests | Brookfield ™ viscosity | Brookfield ™ viscosity at |
|---|---|---|
| No. | at 10 r.p.m. (mPa · s) | 100 r.p.m. (mPa · s) |
| 73 | 13 240 | 10 280 |
| 74 | 2 090 | 1 720 |

The results obtained in table 12 show that it is possible to use aqueous suspensions of ground mineral matter (such as, notably, calcium carbonate) according to the invention, in formulating paper coating according to the invention.

### EXAMPLE 16

This example concerns the use of the dispersing agent according to the invention, in the plastics field.

To accomplish this, the first stage is to filter an aqueous suspension of calcium carbonate, namely marble, obtained after flocculation, to achieve a marble filtration cake of average diameter of 2 μm, as measured using a Sedigraph™ 5100 commercialised by the company MICROMERITICS™.

From this cake, the aqueous suspension of marble is prepared by introducing into the cake the required quantity by dry weight of the dispersing agent according to the invention, as described in test No. 27, relative to the dry weight of the said cake to be put into suspension, in order to obtain an aqueous suspension of marble the dry weight concentration of which is 68%.

When this suspension has been accomplished, it is dried at a temperature of under 105° C. through the use of a laboratory drier of the Niro™ type.

The powder obtained without agglomerates is then divided into two samples, one of which will be subjected to the dispersion test in a thermoplastic resin, and the other of which will be subjected to a dispersion test in a thermosetting resin.

Test No. 75:

This test, illustrating the invention, represents the test for dispersion of the marble powder, obtained above, in a thermoplastic resin.

To accomplish this, 300 grams of prepared powdered marble, the average diameter of which is 2 μm, is introduced into a Guittard mixer with Z-shaped arms with a capacity of 1.5 litres, with a tank heated electrically to 240° C.

After 15 minutes of pre-heating at 240° C. of the filler, 3 grams of commercially available zinc stearate is introduced, together with 125.5 grams of homopolymer polypropylene commercialised by the company Appryl under the name PPH 3120MN1.

This is then mixed for 20 minutes at this temperature and at a speed of 42 r.p.m.

After the mixture was prepared in this manner, calendering was then undertaken of a part of the latter in the form of plates which were cut up into small cubes of side 2 to 3 millimetres, and the MFI fluidity index of which, under a filler of 2.16 kg and 10 kg, with a die of diameter 2.09 mm, was measured at 230° C.

The MFI (Melt Flow Index) obtained is 8.0 g/10 min. under a filler of 2.16 kg with a die of 2.09 mm diameter and at a temperature of 230° C.

The MFI obtained is 132.0 g/10 min under a filler of 2.16 kg with a die of 2.09 mm diameter and at a temperature of 230° C.

These results allow it to be observed that use of the dispersing agent according to the invention is possible in plastic compositions, and notably thermoplastic compositions.

Test No. 76:

This test, illustrating the invention, represents the test for dispersion of the marble powder, obtained above, in a thermosetting resin of unsaturated polyester type.

To accomplish this, 90 grams of unsaturated polyester resin, of reference Palapreg™ P18 from BASF, 60 grams of an additive called “Low Profile”, available under the reference LP40A by UNION CARBIDE™, and 300 grams of the marble powder obtained are weighed in a 500 ml metal box.

After 24 hours™ storage at rest, the presence of a decantation or sedimentation is noted before homogenisation.

The mixture is then homogenised by agitation with a spatula, and the Brookfield™ viscosity at 100 r.p.m. is measured after these 24 hours, using an RVT type Brookfield™ viscometer fitted with module 7.

It is 32,000 mPa·s.

This value shows that the dispersing agent according to the invention may be used in such a pre-mixture of polyester and calcium carbonate, which is itself able to be used to manufacture pre-impregnated products of the SMC (Sheet Moulding Compound) or BMC (Bulk Moulding Compound) types.

1. A process comprising adding to pigments and/or mineral fillers in aqueous suspension, to function as a dispersant and/or a grinding aid agent a water soluble polymer, wherein said water soluble polymer has a controlled structure and is obtained by a controlled free radical polymerization method employing, as polymerization initiator, a particular alkoxyamine with the general formula (A): 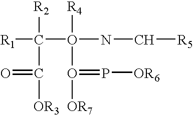
where:
R₁ and R₂ represent a linear or branched alkyl radical, with 1 to 5 carbon atoms,
R₃ is a hydrogen atom, a linear or branched alkyl radical with 1 to 8 carbon atoms, a phenyl radical, a cation such as Li⁺, Na⁺, K⁺, H₄N⁺, Bu₃HN⁺ with Bu=butyl,
R₄ is a linear or branched alkyl radical with 1 to 8 carbon atoms, and preferably a tertbutyl radical,
R₅ is a linear or branched alkyl radical with 1 to 8 carbon atoms, and preferably a tertbutyl radical, and
R₆ and R₇ represent a linear or branched alkyl radical with 1 to 8 carbon atoms, and preferably an ethyl radical.

2. The process according to claim 1, wherein R₁ and R₂ represent the methyl radical and R₃ is the hydrogen atom.

3. The process according to claim 1, wherein said polymer is a water soluble copolymer and has a random, block, comb, graft, or alternating type of structure.

4. The process according to claim 1, wherein said water soluble polymer and/or copolymer is obtained by the controlled free radical polymerization of monomers selected from:
a) at least one ionic monomer, which is either
i) anionic and with a carboxylic or dicarboxylic or phosphoric or phosphonic or sulfonic function or mixture thereof, or
ii) cationic, or
iii) the mixture of i) and ii)
b) and optionally at least one nonionic monomer, the nonionic monomer consisting of at least one monomer with the formula (I): 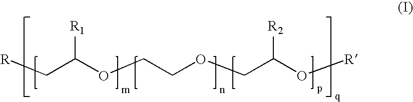
where:
m and p represent a number of alkylene oxide motifs less than or equal to 150,
n is a number of ethylene oxide motifs less than or equal to 150,
q is a whole number at least equal to 1 and such that 5≦(m+n+p)q≦150, and preferably such that 15≦(m+n+p)q≦120,
R₁ is the hydrogen or the methyl or ethyl radical,
R₂ is the hydrogen or the methyl or ethyl radical,
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides, and
R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (I),
c) and optionally at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer or mixtures thereof,
d) and optionally at least one cross-linking monomer, or the mixture of a plurality of these monomers.

5. The process according to claim 1, wherein said water soluble polymer and/or copolymer is obtained by the controlled free radical polymerization of monomers selected more particularly from:
a) at least one ionic monomer which is either
i) anionic with ethylenic unsaturation and with a monocarboxylic function in the acidic or salified state selected from monomers with ethylenic unsaturation and with monocarboxylic function such as acrylic or methacrylic acid or diacid hemiesters such as the C₁ to C₄ monoesters of maleic or itaconic acids, or selected from the monomers with ethylenic unsaturation and dicarboxylic function in the acidic or salified state such as crotonic, isocrotonic, cinnamic, itaconic, maleic acid, or carboxylic acid anhydrides, such as maleic anhydride, or selected from monomers with ethylenic unsaturation and with a sulfonic function in the acidic or salified state such as acrylamido-methyl-propane-sulfonic acid, sodium methallylsulfonate, vinyl sulfonic acid and styrene sulfonic acid, or even selected from monomers with ethylenic unsaturation and with phosphoric function in the acidic or salified state such as vinyl phosphoric acid, ethylene glycol methacrylate phosphate, propylene glycol methacrylate phosphate, ethylene glycol acrylate phosphate, propylene glycol acrylate phosphate and ethoxylates thereof or even selected from monomers with ethylenic unsaturation and with phosphonic function in the acidic or salified state such as vinyl phosphonic acid or mixtures thereof, or
ii) cationic selected from N-[3-(dimethylamino)propyl]acrylamide or N-[3-(dimethylamino)propyl]methacrylamide, unsaturated esters such as N-[2-(dimethylamino)ethyl]methacrylate, or N-[2-(dimethylamino)ethyl]acrylate, or from quaternary ammoniums such as [2-(methacryloyloxy)ethyl]trimethyl ammonium chloride or sulfate, [2-(acryloyloxy)ethyl]trimethyl ammonium chloride or sulfate, [3-(acrylamido)propyl]trimethyl ammonium chloride or sulfate, dimethyl diallyl ammonium chloride or sulfate, [3-(methacrylamido)propyl]trimethyl ammonium chloride or sulfate, or mixtures thereof, or
iii) the mixture of at least one of the above anionic monomers with at least one of the above cationic monomers
b) and optionally at least one monomer with nonionic ethylenic unsaturation with the formula (I): 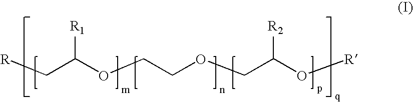
where:
m and p represent a number of alkylene oxide motifs less than or equal to 150,
n is a number of ethylene oxide motifs less than or equal to 150,
q is a whole number at least equal to 1 and such that 5≦(m+n+p)q≦150, and preferably such that 15≦(m+n+p)q≦120,
R₁ is the hydrogen or the methyl or ethyl radical,
R₂ is the hydrogen or the methyl or ethyl radical,
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides, and
R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (I),
c) and optionally at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer selected preferably from the molecules with formulas (IIa) or (IIb):
with formula (IIa) 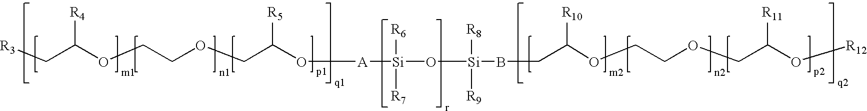
where:
m1, p1, m2 and p2 represent a number of alkylene oxide motifs less than or equal to 150,
n1 and n2 represent a number of ethylene oxide motifs less than or equal to 150,
q1 and q2 represent a whole number at least equal to 1 and such that 0≦(m1+n1+p1)q1≦150 and 0≦(m2+n2+p2)q2≦150,
r is a number such that 1≦r≦200,
R₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R₄, R₅, R₁₀ and R₁₁, represent hydrogen or the methyl or ethyl radical,
R₆, R₇, R₈ and R₉, represent linear or branched alkyl, or aryl, or alkylaryl, or arylalkyl groups with 1 to 20 carbon atoms, or mixtures thereof,
R₁₂ is a hydrocarbon radical with 1 to 40 carbon atoms,
A and B are groups that may be present, which then represent a hydrocarbon radical with 1 to 4 carbon atoms,
with the formula (IIb)
R-A-Si(OB)₃
where:
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
A is a group that may be present, which then represents a hydrocarbon radical with 1 to 4 carbon atoms, and
B is a hydrocarbon radical with 1 to 4 carbon atoms,
or the mixture of a plurality of these monomers,
d) and optionally at least one cross-linking monomer selected from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, allyl ethers obtained from polyols such as pentaerythritol, sorbitol, sucrose, or selected from molecules with the formula (III): 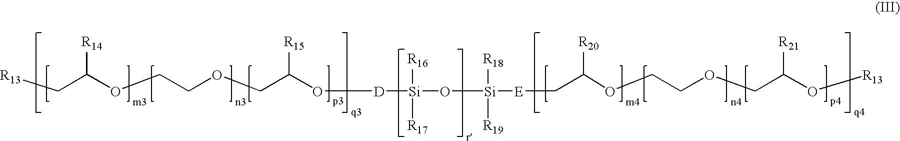
where:
m3, p3, m4 and p4 represent a number of alkylene oxide motifs less than or equal to 150,
n3 and n4 represent a number of ethylene oxide motifs less than or equal to 150,
q3 and q4 represent a whole number at least equal to 1 and such that 0≦(m3+n3+p3)q3≦150 and 0≦(m4+n4+p4)q4≦150,
r′ is a number such that 1≦r′≦200,
R₁₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R₁₄, R₁₅, R₂₀ and R₂₁, represent hydrogen or the methyl or ethyl radical,
R₁₆, R₁₇, R₁₈ and R₁₉, represent linear or branched alkyl, or aryl, or alkylaryl, or arylalkyl groups with 1 to 20 carbon atoms, or mixtures thereof, and
D and E are groups that may be present, which then represent a hydrocarbon radical with 1 to 4 carbon atoms,
or the mixture of a plurality of these monomers.

6. The process according to claim 1, wherein said polymer consists of, expressed by weight:
a) 2% to 100% and even more particularly 5% to 100% of at least one ionic monomer, which is either
i) anionic with ethylenic unsaturation and with a monocarboxylic function in the acidic or salified state selected from monomers with ethylenic unsaturation and with monocarboxylic function such as acrylic or methacrylic acid or diacid hemiesters such as the C₁ to C₄ monoesters of maleic or itaconic acids, or selected from the monomers with ethylenic unsaturation and dicarboxylic function in the acidic or salified state such as crotonic, isocrotonic, cinnamic, itaconic, maleic acid, or carboxylic acid anhydrides, such as maleic anhydride or selected from monomers with ethylenic unsaturation and with a sulfonic function in the acidic or salified state such as acrylamido-methyl-propane-sulfonic acid, sodium methallylsulfonate, vinyl sulfonic acid and styrene sulfonic acid, or even selected from monomers with ethylenic unsaturation and with phosphoric function in the acidic or salified state such as vinyl phosphoric acid, ethylene glycol methacrylate phosphate, propylene glycol methacrylate phosphate, ethylene glycol acrylate phosphate, propylene glycol acrylate phosphate and ethoxylates thereof or even selected from monomers with ethylenic unsaturation and with phosphonic function in the acidic or salified state such as vinyl phosphonic acid or mixtures thereof, or
ii) cationic selected from N-[3-(dimethylamino)propyl]acrylamide or N-[3-(dimethylamino)propyl]methacrylamide, unsaturated esters such as N-[2-(dimethylamino)ethyl]methacrylate, or N-[2-(dimethylamino)ethyl]acrylate, or from quaternary ammoniums such as [2-(methacryloyloxy)ethyl]trimethyl ammonium chloride or sulfate, [2-(acryloyloxy)ethyl]trimethyl ammonium chloride or sulfate, [3-(acrylamido)propyl]trimethyl ammonium chloride or sulfate, dimethyl diallyl ammonium chloride or sulfate, [3-(methacrylamido)propyl]trimethyl ammonium chloride or sulfate, or mixtures thereof, or
iii) the mixture of at least one of the above anionic monomers with at least one of the above cationic monomers,
b) 0 to 98% and even or particularly 0% to 96% of at least one monomer with nonionic ethylenic unsaturation with the formula (I): 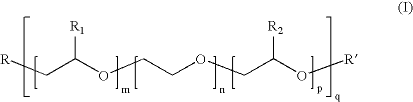
where:
m and p represent a number of alkylene oxide motifs less than or equal to 150,
n is a number of ethylene oxide motifs less than or equal to 150,
q is a whole number at least equal to 1 and such that 5≦(m+n+p)q≦150, and preferably such that 15≦(m+n+p)q≦120,
R₁ is the hydrogen or the methyl or ethyl radical,
R₂ is the hydrogen or the methyl or ethyl radical,
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (I),
c) 0% to 50% of at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer selected preferably from the molecules with formulas (IIa) or (IIb):
with formula (IIa) 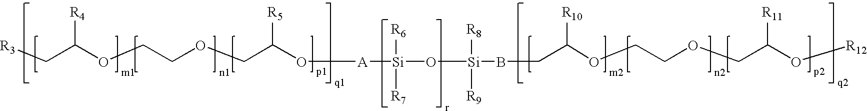
where:
m1, p1, m2 and p2 represent a number of alkylene oxide motifs less than or equal to 150,
n1 and n2 represent a number of ethylene oxide motifs less than or equal to 150,
q1 and q2 represent a whole number at least equal to 1 and such that 0≦(m1+n1+p1)q1≦150 and 0≦(m2+n2+p2)q2≦150,
r is a number such that 1≦r≦200,
R₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R₄, R₅, R₁₀ and R₁₁, represent hydrogen or the methyl or ethyl radical,
R₆, R₇, R₈ and R₉, represent linear or branched alkyl, or aryl, or alkylaryl, or arylalkyl groups with 1 to 20 carbon atoms, or mixtures thereof,
R₁₂ is a hydrocarbon radical with 1 to 40 carbon atoms, and
A and B are groups that may be present, which then represent a hydrocarbon radical with 1 to 4 carbon atoms,
with the formula (IIb)
R-A-Si(OB)₃
where:
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
A is a group that may be present, which then represents a hydrocarbon radical with 1 to 4 carbon atoms, and
B is a hydrocarbon radical with 1 to 4 carbon atoms,
or the mixture of a plurality of these monomers,
d) 0 to 3% of at least one cross-linking monomer selected from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, allyl ethers obtained from polyols such as pentaerythritol, sorbitol, sucrose, or selected from molecules with the formula (III): 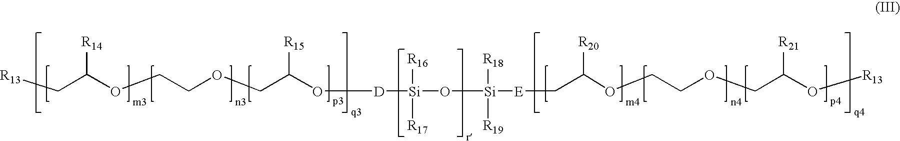
where:
m3, p3, m4 and p4 represent a number of alkylene oxide motifs less than or equal to 150,
n3 and n4 represent a number of ethylene oxide motifs less than or equal to 150,
q3 and q4 represent a whole number at least equal to 1 and such that 0≦(m3+n3+p3)q3≦150 and 0≦(m4+n4+p4)q4≦150,
r′ is a number such that 1≦r′≦200,
R₁₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R₁₄, R₁₅, R₂₀ and R₂₁, represent hydrogen or the methyl or ethyl radical,
R₁₆, R₁₇, R₁₈ and R₁₉, represent linear or branched alkyl, or aryl, or alkylaryl, or arylalkyl groups with 1 to 20 carbon atoms, or mixtures thereof, and
D and E are groups that may be present, which then represent a hydrocarbon radical with 1 to 4 carbon atoms,
or the mixture of a plurality of these monomers.

7. A dispersant and/or grinding aid agent for pigments and/or mineral fillers in aqueous suspension, comprising a water soluble polymer with a controlled structure obtained by a controlled free radical polymerization method employing, as polymerization initiator, a particular alkoxyamine with the general formula (A): 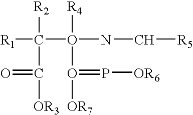
where:
R₁ and R₂ represent a linear or branched alkyl radical, with 1 to 5 carbon atoms,
R₃ is a hydrogen atom, a linear or branched alkyl radical with 1 to 8 carbon atoms, a phenyl radical, a cation such as Li⁺, Na⁺, K⁺, H₄N⁺, Bu₃HN⁺ with Bu=butyl,
R₄ is a linear or branched alkyl radical with 1 to 8 carbon atoms, and preferably a tertbutyl radical, and
R₅ is a linear or branched alkyl radical with 1 to 8 carbon atoms, and preferably a tertbutyl radical, and
R₆ and R₇ represent a linear or branched alkyl radical with 1 to 8 carbon atoms, and preferably an ethyl radical.

8. A dispersant for pigments and/or mineral fillers in aqueous suspension, according to claim 7, wherein R₁ and R₂ represent the methyl radical and R₃ is the hydrogen atom.

9. The dispersant for pigments and/or mineral fillers in aqueous suspension, according to claim 7, wherein said polymer is a water soluble copolymer and has a random, block, comb, graft, or alternating type of structure.

10. The dispersant for pigments and/or mineral fillers in aqueous suspension, according to claim 7, wherein said water soluble polymer is obtained by the controlled free radical polymerization of monomers selected from:
a) at least one ionic monomer, which is either
i) anionic and with a carboxylic or dicarboxylic or phosphoric or phosphonic or sulfonic function or mixture thereof, or
ii) cationic, or
iii) the mixture of i) and ii)
b) and optionally at least one nonionic monomer, the nonionic monomer consisting of at least one monomer with the formula (I): 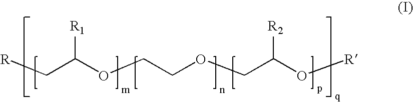
where:
m and p represent a number of alkylene oxide motifs less than or equal to 150,
n is a number of ethylene oxide motifs less than or equal to 150,
q is a whole number at least equal to 1 and such that 5≦(m+n+p)q≦150, and preferably such that 15≦(m+n+p)q≦120,
R₁ is the hydrogen or the methyl or ethyl radical,
R₂ is the hydrogen or the methyl or ethyl radical,
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides, and
R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (I),
c) and optionally at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer or mixtures thereof,
d) and optionally at least one cross-linking monomer, or the mixture of a plurality of these monomers.

11. The dispersant for pigments and/or mineral fillers in aqueous suspension, according to claim 7, wherein said water soluble polymer is obtained by the controlled free radical polymerization of monomers selected more particularly from:
a) at least one ionic monomer which is either
i) anionic with ethylenic unsaturation and with a monocarboxylic function in the acidic or salified state selected from monomers with ethylenic unsaturation and with monocarboxylic function such as acrylic or methacrylic acid or diacid hemiesters such as the C₁ to C₄ monoesters of maleic or itaconic acids, or selected from the monomers with ethylenic unsaturation and dicarboxylic function in the acidic or salified state such as crotonic, isocrotonic, cinnamic, itaconic, maleic acid, or carboxylic acid anhydrides, such as maleic anhydride or selected from monomers with ethylenic unsaturation and with a sulfonic function in the acidic or salified state such as acrylamido-methyl-propane-sulfonic acid, sodium methallylsulfonate, vinyl sulfonic acid and styrene sulfonic acid, or even selected from monomers with ethylenic unsaturation and with phosphoric function in the acidic or salified state such as vinyl phosphoric acid, ethylene glycol methacrylate phosphate, propylene glycol methacrylate phosphate, ethylene glycol acrylate phosphate, propylene glycol acrylate phosphate and ethoxylates thereof or even selected from monomers with ethylenic unsaturation and with phosphonic function in the acidic or salified state such as vinyl phosphonic acid or mixtures thereof, or
ii) cationic selected from N-[3-(dimethylamino)propyl]acrylamide or N-[3-(dimethylamino)propyl]methacrylamide, unsaturated esters such as N-[2-(dimethylamino)ethyl]methacrylate, or N-[2-(dimethylamino)ethyl]acrylate, or from quaternary ammoniums such as [2-(methacryloyloxy)ethyl]trimethyl ammonium chloride or sulfate, [2-(acryloyloxy)ethyl]trimethyl ammonium chloride or sulfate, [3-(acrylamido)propyl]trimethyl ammonium chloride or sulfate, dimethyl diallyl ammonium chloride or sulfate, [3-(methacrylamido)propyl]trimethyl ammonium chloride or sulfate, or mixtures thereof, or
iii) the mixture of at least one of the above anionic monomers with at least one of the above cationic monomers
b) and optionally at least one monomer with nonionic ethylenic unsaturation with the formula (I): 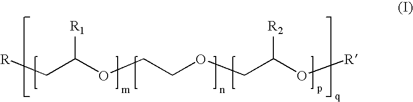
where:
m and p represent a number of alkylene oxide motifs less than or equal to 150,
n is a number of ethylene oxide motifs less than or equal to 150,
q is a whole number at least equal to 1 and such that 5≦(m+n+p)q≦150, and preferably such that 15≦(m+n+p)q≦120,
R₁ is the hydrogen or the methyl or ethyl radical,
R₂ is the hydrogen or the methyl or ethyl radical,
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides, and
R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (I),
c) and optionally at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer selected preferably from the molecules with formulas (IIa) or (IIb):
with formula (IIa) 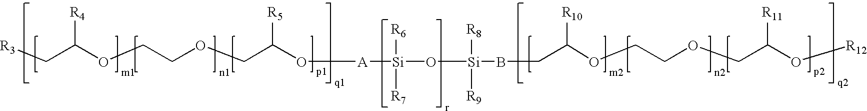
where:
m1, p1, m2 and p2 represent a number of alkylene oxide motifs less than or equal to 150,
n1 and n2 represent a number of ethylene oxide motifs less than or equal to 150,
q1 and q2 represent a whole number at least equal to 1 and such that 0≦(m1+n1+p1)q1≦150 and 0≦(m2+n2+p2)q2≦150,
r is a number such that 1≦r≦200,
R₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R₄, R₅, R₁₀ and R₁₁, represent hydrogen or the methyl or ethyl radical,
R₆, R₇, R₈ and R₉, represent linear or branched alkyl, or aryl, or alkylaryl, or arylalkyl groups with 1 to 20 carbon atoms, or mixtures thereof,
R₁₂ is a hydrocarbon radical with 1 to 40 carbon atoms, and
A and B are groups that may be present, which then represent a hydrocarbon radical with 1 to 4 carbon atoms,
with the formula (IIb)
R-A-Si(OB)₃
where:
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
A is a group that may be present, which then represents a hydrocarbon radical with 1 to 4 carbon atoms, and
B is a hydrocarbon radical with 1 to 4 carbon atoms,
or the mixture of a plurality of these monomers,
d) and optionally at least one cross-linking monomer selected from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, allyl ethers obtained from polyols such as pentaerythritol, sorbitol, sucrose, or selected from molecules with the formula (III): 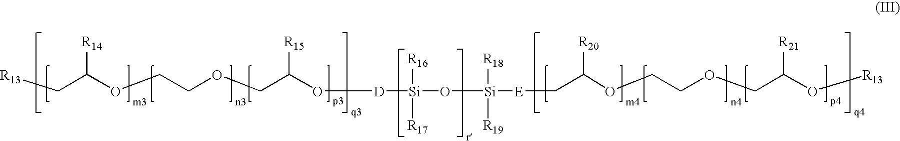
where:
m3, p3, m4 and p4 represent a number of alkylene oxide motifs less than or equal to 150,
n3 and n4 represent a number of ethylene oxide motifs less than or equal to 150,
q3 and q4 represent a whole number at least equal to 1 and such that 0≦(m3+n3+p3)q3≦150 and 0≦(m4+n4+p4)q4≦150,
r′ is a number such that 1≦r′≦200,
R₁₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R₁₄, R₁₅, R₂₀ and R₂₁, represent hydrogen or the methyl or ethyl radical,
R₁₆, R₁₇, R₁₈ and R₁₉, represent linear or branched alkyl, or aryl, or alkylaryl, or arylalkyl groups with 1 to 20 carbon atoms, or mixtures thereof, and
D and E are groups that may be present, which then represent a hydrocarbon radical with 1 to 4 carbon atoms,
or the mixture of a plurality of these monomers.

12. The dispersant for pigments and/or mineral fillers, according to claim 7, wherein said water soluble polymer consists of, expressed by weight:
a) 2% to 100% and even more particularly 5% to 100% of at least one ionic monomer, which is either
i) anionic with ethylenic unsaturation and with a monocarboxylic function in the acidic or salified state selected from monomers with ethylenic unsaturation and with monocarboxylic function such as acrylic or methacrylic acid or diacid hemiesters such as the C₁ to C₄ monoesters of maleic or itaconic acids, or selected from the monomers with ethylenic unsaturation and dicarboxylic function in the acidic or salified state such as crotonic, isocrotonic, cinnamic, itaconic, maleic acid, or carboxylic acid anhydrides, such as maleic anhydride or selected from monomers with ethylenic unsaturation and with a sulfonic function in the acidic or salified state such as acrylamido-methyl-propane-sulfonic acid, sodium methallylsulfonate, vinyl sulfonic acid and styrene sulfonic acid, or even selected from monomers with ethylenic unsaturation and with phosphoric function in the acidic or salified state such as vinyl phosphoric acid, ethylene glycol methacrylate phosphate, propylene glycol methacrylate phosphate, ethylene glycol acrylate phosphate, propylene glycol acrylate phosphate and ethoxylates thereof or even selected from monomers with ethylenic unsaturation and with phosphonic function in the acidic or salified state such as vinyl phosphonic acid or mixtures thereof, or
ii) selected from N-[3-(dimethylamino)propyl]acrylamide or N-[3-(dimethylamino)propyl]methacrylamide, unsaturated esters such as N-[2-(dimethylamino)ethyl]methacrylate, or N-[2-(dimethylamino)ethyl]acrylate, or from quaternary ammoniums such as [2-(methacryloyloxy)ethyl]trimethyl ammonium chloride or sulfate, [2-(acryloyloxy)ethyl]trimethyl ammonium chloride or sulfate, [3-(acrylamido)propyl]trimethyl ammonium chloride or sulfate, dimethyl diallyl ammonium chloride or sulfate, [3-(methacrylamido)propyl]trimethyl ammonium chloride or sulfate, or mixtures thereof, or
iii) the mixture of at least one of the above anionic monomers with at least one of the above cationic monomers,
b) 0 to 98% and even or particularly 0 to 96% of at least one monomer with nonionic ethylenic unsaturation with the formula (I): 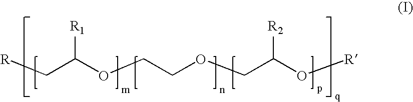
where:
m and p represent a number of alkylene oxide motifs less than or equal to 150,
n is a number of ethylene oxide motifs less than or equal to 150,
q is a whole number at least equal to 1 and such that 5≦(m+n+p)q≦150, and preferably such that 15≦(m+n+p)q≦120,
R₁ is the hydrogen or the methyl or ethyl radical,
R₂ is the hydrogen or the methyl or ethyl radical,
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides, and
R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (I),
c) 0% to 50% of at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer selected preferably from the molecules with formulas (IIa) or (IIb):
with formula (IIa) 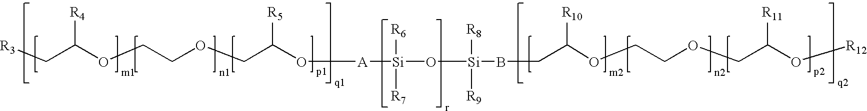
where:
m1, p1, m2 and p2 represent a number of alkylene oxide motifs less than or equal to 150,
n1 and n2 represent a number of ethylene oxide motifs less than or equal to 150,
q1 and q2 represent a whole number at least equal to 1 and such that 0≦(m1+n1+p1)q1≦150 and 0≦(m2+n2+p2)q2≦150,
r is a number such that 1≦r≦200,
R₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R₄, R₅, R₁₀ and R₁₁, represent hydrogen or the methyl or ethyl radical,
R₆, R₇, R₈ and R₉, represent linear or branched alkyl, or aryl, or alkylaryl, or arylalkyl groups with 1 to 20 carbon atoms, or mixtures thereof,
R₁₂ is a hydrocarbon radical with 1 to 40 carbon atoms, and
A and B are groups that may be present, which then represent a hydrocarbon radical with 1 to 4 carbon atoms, with the formula (IIb)
R-A-Si(OB)₃
where:
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
A is a group that may be present, which then represents a hydrocarbon radical with 1 to 4 carbon atoms, and
B is a hydrocarbon radical with 1 to 4 carbon atoms,
or the mixture of a plurality of these monomers,
d) 0 to 3% of at least one cross-linking monomer selected from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, allyl ethers obtained from polyols such as pentaerythritol, sorbitol, sucrose, or selected from molecules with the formula (III): 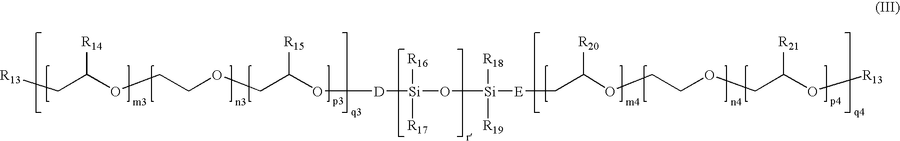
where:
m3, p3, m4 and p4 represent a number of alkylene oxide motifs less than or equal to 150,
n3 and n4 represent a number of ethylene oxide motifs less than or equal to 150,
q3 and q4 represent a whole number at least equal to 1 and such that 0≦(m3+n3+p3)q3≦150 and 0≦(m4+n4+p4)q4≦150,
r′ is a number such that 1≦r′≦200,
R₁₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R₁₄, R₁₅, R₂₀ and R₂₁, represent hydrogen or the methyl or ethyl radical,
R₁₆, R₁₇, R₁₈ and R₁₉, represent linear or branched alkyl, or aryl, or alkylaryl, or arylalkyl groups with 1 to 20 carbon atoms, or mixtures thereof, and
D and E are groups that may be present, which then represent a hydrocarbon radical with 1 to 4 carbon atoms,
or the mixture of a plurality of these monomers.

13. A grinding aid agent for pigments and/or mineral fillers in aqueous suspension, comprising a water soluble polymer with a controlled structure obtained by a controlled free radical polymerization method employing, as polymerization initiator, a particular alkoxyamine with the general formula (A): 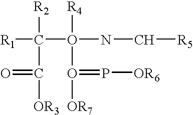
where:
R₁ and R₂ represent a linear or branched alkyl radical, with 1 to 5 carbon atoms,
R₃ is a hydrogen atom, a linear or branched alkyl radical with 1 to 8 carbon atoms, a phenyl radical, a cation such as Li⁺, Na⁺, K⁺, H₄N⁺, Bu₃HN⁺ with Bu=butyl,
R₄ is a linear or branched alkyl radical with 1 to 8 carbon atoms, and preferably a tertbutyl radical,
R₅ is a linear or branched alkyl radical with 1 to 8 carbon atoms, and preferably a tertbutyl radical, and
R₆ and R₇ represent a linear or branched alkyl radical with 1 to 8 carbon atoms, and preferably an ethyl radical.

14. The grinding aid agent for pigments and/or mineral fillers in aqueous suspension, according to claim 13, wherein R₁ and R₂ represent the methyl radical and R₃ is the hydrogen atom.

15. The grinding aid agent for pigments and/or mineral fillers in aqueous suspension, according to claim 13, wherein said polymer is a water soluble copolymer and has a random, block, comb, graft, or alternating type of structure.

16. The grinding aid agent for pigments and/or mineral fillers in aqueous suspension, according to claim 13, wherein said water soluble polymer is obtained by the controlled free radical polymerization of monomers selected from:
a) at least one ionic monomer, which is either
i) anionic and with a carboxylic or dicarboxylic or phosphoric or phosphonic or sulfonic function or mixture thereof, or
ii) cationic, or
iii) the mixture of i) and ii)
b) and optionally at least one nonionic monomer, the nonionic monomer consisting of at least one monomer with the formula (I): 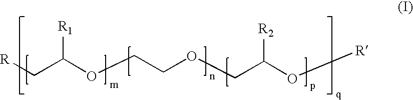
where:
m and p represent a number of alkylene oxide motifs less than or equal to 150,
n is a number of ethylene oxide motifs less than or equal to 150,
q is a whole number at least equal to 1 and such that 5≦(m+n+p)q≦150, and preferably such that 15≦(m+n+p)q≦120,
R₁ is the hydrogen or the methyl or ethyl radical,
R₂ is the hydrogen or the methyl or ethyl radical,
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides, and
R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (I),
c) and optionally at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer or mixtures thereof,
d) and possibly at least one cross-linking monomer, or the mixture of a plurality of these monomers.

17. The grinding aid agent for pigments and/or mineral fillers in aqueous suspension, according to claim 13, wherein said water soluble polymer is obtained by the controlled free radical polymerization of monomers selected more particularly from:
a) at least one ionic monomer which is either
i) anionic with ethylenic unsaturation and with a monocarboxylic function in the acidic or salified state selected from monomers with ethylenic unsaturation and with monocarboxylic function such as acrylic or methacrylic acid or diacid hemiesters such as the C₁ to C₄ monoesters of maleic or itaconic acids, or selected from the monomers with ethylenic unsaturation and dicarboxylic function in the acidic or salified state such as crotonic, isocrotonic, cinnamic, itaconic, maleic acid, or carboxylic acid anhydrides, such as maleic anhydride or selected from monomers with ethylenic unsaturation and with a sulfonic function in the acidic or salified state such as acrylamido-methyl-propane-sulfonic acid, sodium methallylsulfonate, vinyl sulfonic acid and styrene sulfonic acid, or even selected from monomers with ethylenic unsaturation and with phosphoric function in the acidic or salified state such as vinyl phosphoric acid, ethylene glycol methacrylate phosphate, propylene glycol methacrylate phosphate, ethylene glycol acrylate phosphate, propylene glycol acrylate phosphate and ethoxylates thereof or even selected from monomers with ethylenic unsaturation and with phosphonic function in the acidic or salified state such as vinyl phosphonic acid or mixtures thereof, or
ii) cationic selected from N-[3-(dimethylamino)propyl]acrylamide or N-[3-(dimethylamino)propyl]methacrylamide, unsaturated esters such as N-[2-(dimethylamino)ethyl]methacrylate, or N-[2-(dimethylamino)ethyl]acrylate, or from quaternary ammoniums such as [2-(methacryloyloxy)ethyl]trimethyl ammonium chloride or sulfate, [2-(acryloyloxy)ethyl]trimethyl ammonium chloride or sulfate, [3-(acrylamido)propyl]trimethyl ammonium chloride or sulfate, dimethyl diallyl ammonium chloride or sulfate, [3-(methacrylamido)propyl]trimethyl ammonium chloride or sulfate, or mixtures thereof, or
iii) the mixture of at least one of the above anionic monomers with at least one of the above cationic monomers
b) and optionally at least one monomer with nonionic ethylenic unsaturation with the formula (I): 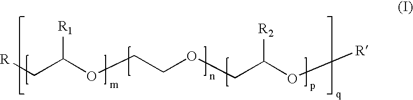
where:
m and p represent a number of alkylene oxide motifs less than or equal to 150,
n is a number of ethylene oxide motifs less than or equal to 150,
q is a whole number at least equal to 1 and such that 5≦(m+n+p)q≦150, and preferably such that 15≦(m+n+p)q≦120,
R₁ is the hydrogen or the methyl or ethyl radical,
R₂ is the hydrogen or the methyl or ethyl radical,
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides, and
R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (1),
c) and optionally at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer selected preferably from the molecules with formulas (IIa) or (IIb):
with formula (IIa) 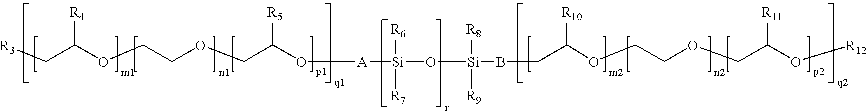
where:
m1, p1, m2 and p2 represent a number of alkylene oxide motifs less than or equal to 150,
n1 and n2 represent a number of ethylene oxide motifs less than or equal to 150,
q1 and q2 represent a whole number at least equal to 1 and such that 0≦(m1+n1+p1)q1≦150 and 0≦(m2+n2+p2)q2≦150,
r is a number such that 1≦r≦200,
R₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R₄, R₅, R₁₀ and R₁₁, represent hydrogen or the methyl or ethyl radical,
R₆, R₇, R₈ and R₉, represent linear or branched alkyl, or aryl, or alkylaryl, or arylalkyl groups with 1 to 20 carbon atoms, or mixtures thereof,
R₁₂ is a hydrocarbon radical with 1 to 40 carbon atoms,
A and B are groups that may be present, which then represent a hydrocarbon radical with 1 to 4 carbon atoms,
with the formula (IIb)
R-A-Si(OB)₃
where:
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
A is a group that may be present, which then represents a hydrocarbon radical with 1 to 4 carbon atoms, and
B is a hydrocarbon radical with 1 to 4 carbon atoms,
or the mixture of a plurality of these monomers,
d) and optionally at least one cross-linking monomer selected from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, allyl ethers obtained from polyols such as pentaerythritol, sorbitol, sucrose, or selected from molecules with the formula (III): 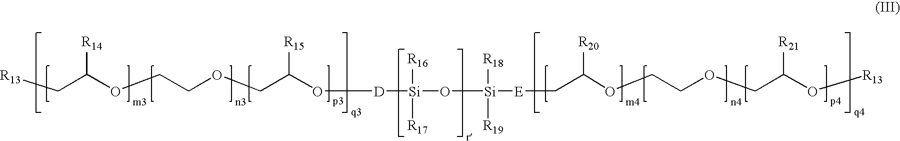
where:
m3, p3, m4 and p4 represent a number of alkylene oxide motifs less than or equal to 150,
n3 and n4 represent a number of ethylene oxide motifs less than or equal to 150,
q3 and q4 represent a whole number at least equal to 1 and such that 0≦(m3+n3+p3)q3≦150 and 0≦(m4+n4+p4)q4≦150,
r′ is a number such that 1≦r′≦200,
R₁₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R₁₄, R₁₅, R₂₀ and R₂₁, represent hydrogen or the methyl or ethyl radical,
R₁₆, R₁₇, R₁₈ and R₁₉, represent linear or branched alkyl, or aryl, or alkylaryl, or arylalkyl groups with 1 to 20 carbon atoms, or mixtures thereof, and
D and E are groups that may be present, which then represent a hydrocarbon radical with 1 to 4 carbon atoms,
or the mixture of a plurality of these monomers.

18. The grinding aid agent for pigments and/or mineral fillers, according to claim 13, wherein said water soluble polymer consists of, expressed by weight:
a) 2% to 100% and even more particularly 5% to 100% of at least one ionic monomer, which is either
i) anionic with ethylenic unsaturation and with a monocarboxylic function in the acidic or salified state selected from monomers with ethylenic unsaturation and with monocarboxylic function such as acrylic or methacrylic acid or diacid hemiesters such as the C₁ to C₄ monoesters of maleic or itaconic acids, or selected from the monomers with ethylenic unsaturation and dicarboxylic function in the acidic or salified state such as crotonic, isocrotonic, cinnamic, itaconic, maleic acid, or carboxylic acid anhydrides, such as maleic anhydride or selected from monomers with ethylenic unsaturation and with a sulfonic function in the acidic or salified state such as acrylamido-methyl-propane-sulfonic acid, sodium methallylsulfonate, vinyl sulfonic acid and styrene sulfonic acid, or even selected from monomers with ethylenic unsaturation and with phosphoric function in the acidic or salified state such as vinyl phosphoric acid, ethylene glycol methacrylate phosphate, propylene glycol methacrylate phosphate, ethylene glycol acrylate phosphate, propylene glycol acrylate phosphate and ethoxylates thereof or even selected from monomers with ethylenic unsaturation and with phosphonic function in the acidic or salified state such as vinyl phosphonic acid or mixtures thereof, or
ii) selected from N-[3-(dimethylamino)propyl]acrylamide or N-[3-(dimethylamino)propyl]methacrylamide, unsaturated esters such as N-[2-(dimethylamino)ethyl]methacrylate, or N-[2-(dimethylamino)ethyl]acrylate, or from quaternary ammoniums such as [2-(methacryloyloxy)ethyl]trimethyl ammonium chloride or sulfate, [2-(acryloyloxy)ethyl]trimethyl ammonium chloride or sulfate, [3-(acrylamido)propyl]trimethyl ammonium chloride or sulfate, dimethyl diallyl ammonium chloride or sulfate, [3-(methacrylamido)propyl]trimethyl ammonium chloride or sulfate, or mixtures thereof, or
iii) the mixture of at least one of the above anionic monomers with at least one of the above cationic monomers,
b) 0 to 98% and even or particularly 0% to 96% of at least one monomer with nonionic ethylenic unsaturation with the formula (I): 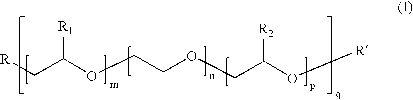
where:
m and p represent a number of alkylene oxide motifs less than or equal to 150,
n is a number of ethylene oxide motifs less than or equal to 150,
q is a whole number at least equal to 1 and such that 5≦(m+n+p)q≦150, and preferably such that 15≦(m+n+p)q≦120,
R₁ is the hydrogen or the methyl or ethyl radical,
R₂ is the hydrogen or the methyl or ethyl radical,
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides, and
R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (I),
c) 0% to 50% of at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer selected preferably from the molecules with formulas (IIa) or (IIb):
with formula (IIa) 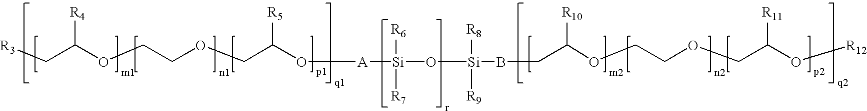
where:
m1, p1, m2 and p2 represent a number of alkylene oxide motifs less than or equal to 150,
n1 and n2 represent a number of ethylene oxide motifs less than or equal to 150,
q1 and q2 represent a whole number at least equal to 1 and such that 0≦(m1+n1+p1)q1≦150 and 0≦(m2+n2+p2)q2≦150,
r is a number such that 1≦r≦200,
R₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R₄, R₅, R₁₀ and R₁₁, represent hydrogen or the methyl or ethyl radical,
R₆, R₇, R₈ and R₉, represent linear or branched alkyl, or aryl, or alkylaryl, or arylalkyl groups with 1 to 20 carbon atoms, or mixtures thereof,
R₁₂ is a hydrocarbon radical with 1 to 40 carbon atoms, and
A and B are groups that may be present, which then represent a hydrocarbon radical with 1 to 4 carbon atoms,
with the formula (IIb)
R-A-Si(OB)₃
where:
R is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
A is a group that may be present, which then represents a hydrocarbon radical with 1 to 4 carbon atoms, and
B is a hydrocarbon radical with 1 to 4 carbon atoms,
or the mixture of a plurality of these monomers,
d) 0 to 3% of at least one cross-linking monomer selected from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, allyl ethers obtained from polyols such as pentaerythritol, sorbitol, sucrose, or selected from molecules with the formula (III): 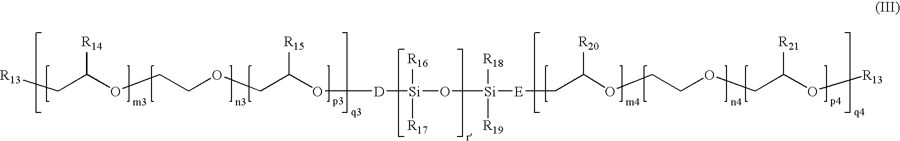
where:
m3, p3, m4 and p4 represent a number of alkylene oxide motifs less than or equal to 150,
n3 and n4 represent a number of ethylene oxide motifs less than or equal to 150,
q3 and q4 represent a whole number at least equal to 1 and such that 0≦(m3+n3+p3)q3≦150 and 0≦(m4+n4+p4)q4≦150,
r′ is a number such that 1≦r′≦200,
R₁₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as acrylurethane, methacrylurethane, α-α′dimethyl-isopropenyl-benzylurethane, allylurethane, and also to the group of allyl or vinyl ethers, substituted or not, or to the group of ethylenically unsaturated amides or imides,
R₁₄, R₁₅, R₂₀ and R₂₁, represent hydrogen or the methyl or ethyl radical,
R₁₆, R₁₇, R₁₈ and R₁₉, represent linear or branched alkyl, or aryl, or alkylaryl, or arylalkyl groups with 1 to 20 carbon atoms, or mixtures thereof, and
D and E are groups that may be present, which then represent a hydrocarbon radical with 1 to 4 carbon atoms,
or the mixture of a plurality of these monomers.

19. (canceled)

20. The method for dispersing pigments and/or mineral fillers in aqueous suspension according to claim 1, wherein 0.05 to 5% by dry weight of said polymer is used, and more particularly 0.1 to 3% by dry weight of said polymer is used, with respect to the dry weight of pigments and/or mineral fillers.

21. The method for dispersing pigments and/or mineral fillers according to claim 20, wherein the pigment and/or mineral fillers are selected from natural or synthetic calcium carbonate, dolomites, kaolonite, talc, cement, gypsum, lime, magnesia, titanium oxide, satin white, aluminum trioxide or even aluminum trihydroxide, silicas, mica and the mixture of these fillers together, such as the talc-calcium carbonate, calcium carbonate-kaolinite mixtures, or even mixtures of calcium carbonate with aluminum trihydroxide or aluminum trioxide, or even mixtures with synthetic or natural fibers or even co-structures of minerals such as the talc-calcium carbonate or talc-titanium dioxide co-structures or mixtures thereof, and more particularly from natural calcium carbonate, synthetic calcium carbonate, and cement and very particularly from marble, calcite, chalk or mixtures thereof.

22. A method for grinding pigments and/or mineral fillers comprising grinding pigments and/or mineral fillers in the presence of a water soluble copolymer of claim 1.

23. The method for grinding pigments and/or mineral fillers in aqueous suspension according to claim 22, wherein 0.05 to 5% by dry weight of said polymer is used, and more particularly 0.1 to 3% by dry weight of said polymer is used, with respect to the dry weight of pigments and/or mineral fillers.

24. The method for grinding pigments and/or mineral fillers according to claim 22, wherein the pigment and/or mineral fillers are selected from natural or synthetic calcium carbonate, dolomites, kaolonite, talc, gypsum, lime, magnesia, titanium oxide, satin white, aluminum trioxide or even aluminum trihydroxide, silicas, mica and the mixture of these fillers together, such as the talc-calcium carbonate, calcium carbonate-kaolinite mixtures, or even mixtures of calcium carbonate with aluminum trihydroxide or aluminum trioxide, or even mixtures with synthetic or natural fibers or even co-structures of minerals such as the talc-calcium carbonate or talc-titanium dioxide co-structures or mixtures thereof, and more particularly from natural calcium carbonate, synthetic calcium carbonate, and very particularly from marble, calcite, chalk or mixtures thereof.

25. An aqueous dispersion of pigments and/or mineral fillers comprising the water soluble polymer according to claim 1, and more particularly in that it contains 0.05 to 5% by dry weight of said polymer, and more particularly in that it contains 0.1 to 3% by dry weight of said polymer, with respect to the dry weight of pigments and/or mineral fillers.

26. The aqueous dispersion of pigments and/or mineral fillers according to claim 25, wherein the pigments and/or mineral fillers are selected from natural or synthetic calcium carbonate, dolomites, kaolonite, talc, cement, gypsum, lime, magnesia, titanium oxide, satin white, aluminum trioxide or even aluminum trihydroxide, silicas, mica and the mixture of these fillers together, such as the talc-calcium carbonate, calcium carbonate-kaolinite mixtures, or even mixtures of calcium carbonate with aluminum trihydroxide or aluminum trioxide, or even mixtures with synthetic or natural fibers or even co-structures of minerals such as the talc-calcium carbonate or talc-titanium dioxide co-structures or mixtures thereof, and more particularly from natural calcium carbonate, synthetic calcium carbonate, and very particularly from marble, calcite, chalk or mixtures thereof.

27. An aqueous suspension of ground pigments and/or mineral fillers comprising the water soluble polymer according to claim 1, and more particularly in that it contains 0.05 to 5% by dry weight of said polymer, and more particularly in that it contains 0.1 to 3% by dry weight of said polymer, with respect to the dry weight of pigments and/or mineral fillers.

28. The aqueous suspension of ground pigments and/or mineral fillers according to claim 27, wherein the pigment and/or mineral fillers are selected from natural or synthetic calcium carbonate, dolomites, kaolonite, talc, gypsum, lime, magnesia, titanium oxide, satin white, aluminum trioxide or even aluminum trihydroxide, silicas, mica and the mixture of these fillers together, such as the talc-calcium carbonate, calcium carbonate-kaolinite mixtures, or even mixtures of calcium carbonate with aluminum trihydroxide or aluminum trioxide, or even mixtures with synthetic or natural fibers or even co-structures of minerals such as the talc-calcium carbonate or talc-titanium dioxide co-structures or mixtures thereof, and more particularly from natural calcium carbonate, synthetic calcium carbonate, and very particularly from marble, calcite, chalk or mixtures thereof.

29. A paper, water based paints, plastics, cement, ceramics or detergents comprising the aqueous dispersion of pigments and/or mineral fillers according to claim 25.

30. A paper, water based paints, plastics, cement, ceramics or detergents comprising the aqueous suspension of ground pigments and/or mineral fillers according to claim 27.

31. A method for dispersing mineral matter in a paper formulation, in a water based paint, in a cement, in a ceramic composition, in a detergent composition, in a drilling mud, comprising including therein the water soluble polymer according to claim 1.

32. (canceled)

33. A paper formulation containing 0.01 to 5% by dry weight of the water soluble polymer according to claim 1.

34. A water based paint containing 0.01 to 5% by dry weight of the water soluble polymer according to claim 1.

35. A plastic composition containing 0.01 to 5% by dry weight of the water soluble polymer according to claim 1.

36. A cement containing 0.01 to 5% by dry weight of the water soluble polymer according to claim 1.

37. A ceramic composition containing 0.01 to 5% by dry weight of the water soluble polymer according to claim 1.

38. A detergent composition containing 0.01 to 5% by dry weight of the water soluble polymer according to claim 1.

39. A cosmetic composition containing 0.01 to 5% by dry weight of the water soluble polymer according to claim 1.

40. A drilling mud composition containing 0.01 to 5% by dry weight of the water soluble polymer according to claim 1.
